(19) United States
(12) Patent Application Publication
(10) Pub. No.: US 2025/0154854 A1
(43) Pub. Date: May 15, 2025

(54) FIELD ASSET FRAMEWORK

(71) Applicant: Schlumberger Technology Corporation, Sugar Land, TX (US)

(72) Inventor: Hussein Mustapha, Abu Dhabi (AE)

(21) Appl. No.: 18/839,349

(22) PCT Filed: Jun. 21, 2023
(86) PCT No.: PCT/US2023/068758

§ 371 Date: Aug. 16, 2024

Related U.S. Application Data
(60) Provisional application No. 63/354,080, filed on Jun. 21, 2022.

(51) Int. Cl. E21B 41/00

(52) U.S. Cl. CPC E21B 41/0099; E21B 2200/22

(57) ABSTRACT

A computational framework can include a network interface that receives data from multiple field sites; a processor-based predictor that utilizes at least a portion of the data to generate predictions for production and emissions at each of the multiple field sites; and a processor-based pathway generator that utilizes the predictions to generate an action pathway with different actions for implementation at one or more of the multiple field sites.

### RELATED APPLICATION

This application claims priority to and the benefit of a US Provisional Application having Ser. No. 63/354,080, filed 21 Jun. 2022, which is incorporated by reference herein in its entirety.

### BACKGROUND

A reservoir can be a subsurface formation that can be characterized at least in part by its porosity and fluid permeability. As an example, a reservoir may be part of a basin such as a sedimentary basin. A basin can be a depression (e.g., caused by plate tectonic activity, subsidence, etc.) in which sediments accumulate. As an example, where hydrocarbon source rocks occur in combination with appropriate depth and duration of burial, a petroleum system may develop within a basin, which may form a reservoir that includes hydrocarbon fluids (e.g., oil, gas, etc.).

In oil and gas exploration, interpretation is a process that involves analysis of data to identify and locate various subsurface structures (e.g., horizons, faults, geobodies, etc.) in a geologic environment. Various types of structures (e.g., stratigraphic formations) may be indicative of hydrocarbon traps or flow channels, as may be associated with one or more reservoirs (e.g., fluid reservoirs). In the field of resource extraction, enhancements to interpretation can allow for construction of a more accurate model of a subsurface region, which, in turn, may improve characterization of the subsurface region for purposes of resource extraction. Characterization of one or more subsurface regions in a geologic environment can guide, for example, performance of one or more operations (e.g., field operations, etc.). As an example, a more accurate model of a subsurface region may make a drilling operation more accurate as to a borehole's trajectory where the borehole is to have a trajectory that penetrates a reservoir, etc., where fluid may be produced via the borehole (e.g., as a completed well, etc.). As an example, one or more workflows may be performed using one or more computational frameworks and/or one or more pieces of equipment that include features for one or more of analysis, acquisition, model building, control, etc., for exploration, interpretation, drilling, fracturing, production, etc.

### SUMMARY

A computational framework can include a network interface that receives data from multiple field sites; a processor-based predictor that utilizes at least a portion of the data to generate predictions for production and emissions at each of the multiple field sites; and a processor-based pathway generator that utilizes the predictions to generate an action pathway with different actions for implementation at one or more of the multiple field sites.

A method can include receiving data from multiple field sites; using at least a portion of the data, generating predictions for production and emissions at each of the multiple field sites; and using the predictions, generating an action pathway with different actions for implementation at one or more of the multiple field sites.

One or more non-transitory computer-readable storage media can include computer-executable instructions executable to instruct a computing system to: receive data from multiple field sites; using at least a portion of the data, generating predictions for production and emissions at each of the multiple field sites; and using the predictions, generating an action pathway with different actions for implementation at one or more of the multiple field sites.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example of a geologic environment and an example of a system;

FIG. 2 illustrates an example of a system;

FIG. 3 illustrates an example of a system;

FIG. 4 illustrates an example of a system;

FIG. 5 illustrates an example of a system;

FIG. 6 illustrates an example of a graphical user interface;

FIG. 7 illustrates an example of a graphical user interface;

FIG. 8 illustrates an example of a graphical user interface;

FIG. 9 illustrates an example of a graphical user interface;

FIG. 10 illustrates an example of a graphical user interface;

FIG. 11 illustrates an example of a graphical user interface;

FIG. 12 illustrates an example of a graphical user interface;

FIG. 13 illustrates an example of a graphical user interface;

FIG. 14 illustrates an example of a graphical user interface;

FIG. 15 illustrates an example of a graphical user interface;

FIG. 16 illustrates an example of a graphical user interface;

FIG. 17 illustrates an example of a graphical user interface;

FIG. 18 illustrates an example of a graphical user interface;

FIG. 19 illustrates an example of a graphical user interface;

FIG. 20 illustrates an example of a method, an example of a computational framework, and an example of a system; and

FIG. 21 illustrates example components of a system and a networked system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

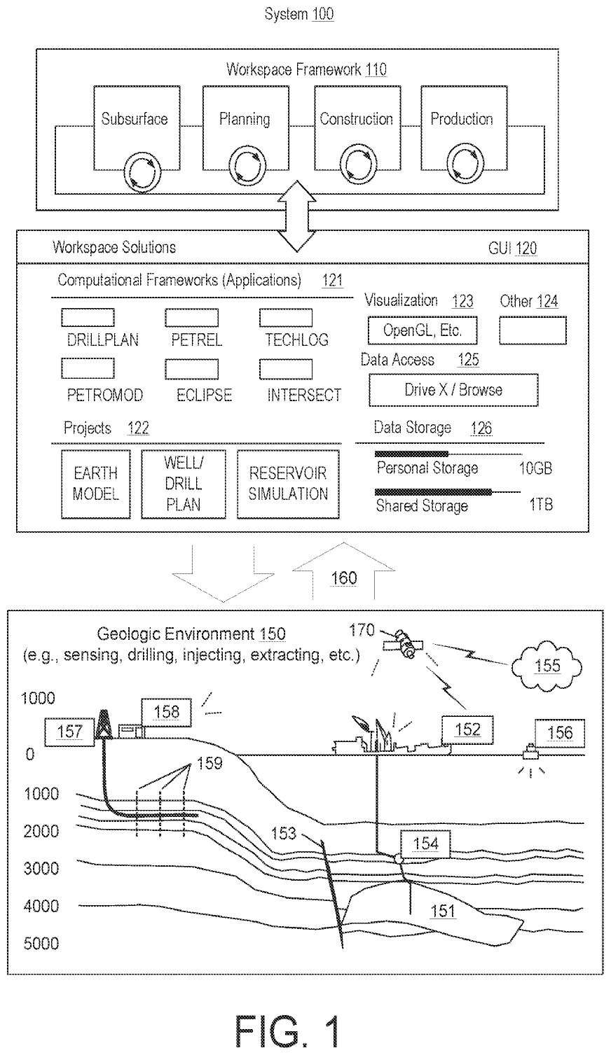

FIG. 1 shows an example of a system 100 that includes a workspace framework 110 that can provide for instantiation of, rendering of, interactions with, etc., a graphical user interface (GUI) 120. In the example of FIG. 1, the GUI 120 can include graphical controls for computational frameworks (e.g., applications) 121, projects 122, visualization 123, one or more other features 124, data access 125, and data storage 126.

In the example of FIG. 1, the workspace framework 110 may be tailored to a particular geologic environment such as an example geologic environment 150. For example, the geologic environment 150 may include layers (e.g., stratification) that include a reservoir 151 and that may be intersected by a fault 153. As an example, the geologic environment 150 may be outfitted with a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a wellsite and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite 170 in communication with the network 155 that may be configured for communications, noting that the satellite may additionally or alternatively include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

In the example of FIG. 1, the GUI 120 shows some examples of computational frameworks, including the DRILLPLAN, PETREL, TECHLOG, PETROMOD, ECLIPSE, and INTERSECT frameworks (SLB, Houston, Texas).

The DRILLPLAN framework provides for digital well construction planning and includes features for automation of repetitive tasks and validation workflows, enabling improved quality drilling programs (e.g., digital drilling plans, etc.) to be produced quickly with assured coherency.

The PETREL framework can be part of the DELFI cognitive exploration and production (E&P) environment (SLB, Houston, Texas), referred to as the DELFI environment, for utilization in geosciences and geoengineering, for example, to analyze subsurface data from exploration to production of fluid from a reservoir.

The DELFI environment is a secure, cognitive, cloud-based collaborative environment that integrates data and workflows with digital technologies, such as artificial intelligence and machine learning. As an example, such an environment can provide for operations that involve one or more frameworks. The DELFI environment may be referred to as the DELFI framework, which may be a framework of frameworks. As an example, the DELFI framework can include various other frameworks, which can include, for example, one or more types of models (e.g., simulation models, machine learning models, etc.).

The TECHLOG framework can handle and process field and laboratory data for a variety of geologic environments (e.g., deepwater exploration, shale, etc.). The TECHLOG framework can structure borehole data for analyses, planning, etc.

The PETROMOD framework provides petroleum systems modeling capabilities that can combine one or more of seismic, well, and geological information to model evolution of a sedimentary basin. The PETROMOD framework can predict if, and how, a reservoir has been charged with hydrocarbons, including the source and timing of hydrocarbon generation, migration routes, quantities, and hydrocarbon type in the subsurface or at surface conditions.

The ECLIPSE framework provides a reservoir simulator (e.g., as a computational framework) with numerical solutions for fast and accurate prediction of dynamic behavior for various types of reservoirs and development schemes.

The INTERSECT framework provides a high-resolution reservoir simulator for simulation of detailed geological features and quantification of uncertainties, for example, by creating accurate production scenarios and, with the integration of precise models of the surface facilities and field operations, the INTERSECT framework can produce reliable results, which may be continuously updated by real-time data exchanges (e.g., from one or more types of data acquisition equipment in the field that can acquire data during one or more types of field operations, etc.). The INTERSECT framework can provide completion configurations for complex wells where such configurations can be built in the field, can provide detailed chemical-enhanced-oil-recovery (chemical EOR) formulations where such formulations can be implemented in the field, can analyze application of steam injection and other thermal EOR techniques for implementation in the field, advanced production controls in terms of reservoir coupling and flexible field management, and flexibility to script customized solutions for improved modeling and field management control. The INTERSECT framework, as with the other example frameworks, may be utilized as part of the DELFI environment, for example, for rapid simulation of multiple concurrent cases. For example, a workflow may utilize one or more of the DELFI environment on demand reservoir simulation features.

The aforementioned DELFI environment provides various features for workflows as to subsurface analysis, planning, construction and production, for example, as illustrated in the workspace framework 110. As shown in FIG. 1, outputs from the workspace framework 110 can be utilized for directing, controlling, etc., one or more processes in the geologic environment 150 and, feedback 160, can be received via one or more interfaces in one or more forms (e.g., acquired data as to operational conditions, equipment conditions, environment conditions, etc.).

While several simulators are illustrated in the example of FIG. 1, one or more other simulators may be utilized, additionally or alternatively. For example, consider the VISAGE geomechanics simulator (SLB, Houston Texas) or the PIPESIM network simulator (SLB, Houston Texas), etc. The VISAGE simulator includes finite element numerical solvers that may provide simulation results such as, for example, results as to compaction and subsidence of a geologic environment, well and completion integrity in a geologic environment, cap-rock and fault-seal integrity in a geologic environment, fracture behavior in a geologic environment, thermal recovery in a geologic environment, CO2 disposal, etc. The PIPESIM simulator includes solvers that may provide simulation results such as, for example, multiphase flow results (e.g., from a reservoir to a wellhead and beyond, etc.), flowline and surface facility performance, etc. The PIPESIM simulator may be integrated, for example, with the AVOCET production operations framework (SLB, Houston, Texas).

In the example of FIG. 1, the visualization features 123 may be implemented via the workspace framework 110, for example, to perform tasks as associated with one or more of subsurface regions, planning operations, constructing wells and/or surface fluid networks, and producing from a reservoir.

As an example, visualization features can provide for visualization of various earth models, properties, etc., in one or more dimensions. As an example, visualization features can provide for rendering of information in multiple dimensions, which may optionally include multiple resolution rendering. In such an example, information being rendered may be associated with one or more frameworks and/or one or more data stores. As an example, visualization features may include one or more control features for control of equipment, which can include, for example, field equipment that can perform one or more field operations. As an example, a workflow may utilize one or more frameworks to generate information that can be utilized to control one or more types of field equipment (e.g., drilling equipment, wireline equipment, fracturing equipment, etc.).

As an example, a model may be a simulated version of an environment, which may include one or more sites of possible emissions. As an example, a simulator may include features for simulating physical phenomena in an environment based at least in part on a model or models. A simulator, such as a weather simulator, can simulate fluid flow in an environment based at least in part on a model that can be generated via a framework that receives satellite data. A simulator can be a computerized system (e.g., a computing system) that can execute instructions using one or more processors to solve a system of equations that describe physical phenomena subject to various constraints. In such an example, the system of equations may be spatially defined (e.g., numerically discretized) according to a spatial model (e.g., of the Earth, the atmosphere, the oceans, etc.).

Phenomena associated with a sedimentary basin (e.g., a subsurface region, whether below a ground surface, water surface, etc.) may be modeled using various equations (e.g., stress, fluid flow, phase, etc.). As an example, a numerical model of a basin may find use for understanding various processes related to exploration and production of natural resources (e.g., estimating reserves in place, drilling wells, forecasting production, controlling fracturing, etc.).

For application of a numerical technique, equations may be discretized using nodes, cells, etc. For example, a numerical technique such as the finite difference method can include discretizing a differential heat equation for temperature with respect to a spatial coordinate or spatial coordinates to approximate temperature derivatives (e.g., first order, second order, etc.). While temperature is mentioned, the finite difference method can be utilized for one or more of various variables (e.g., pressure, fluid flow, stress, strain, emissions, etc.). Further, where time is of interest, a derivative of a variable or variables with respect to time may be provided.

As to a spatial coordinate or spatial coordinates, a numerical technique may rely on a spatial grid that includes various nodes where one or more variables such as, for example, temperature, pressure, fluid velocity, etc., can be provided for the nodes upon solving appropriate equations (e.g., subject to boundary conditions, generation terms, etc.). Such an example may apply to multiple dimensions in space (e.g., where discretization is applied to the multiple dimensions). Thus, a grid may discretize a volume of interest (VOI) into elementary elements (e.g., points, cells or grid blocks) that may be assigned or associated with properties (e.g., porosity, permeability, rock type, etc.), which may be germane to simulation of physical processes (e.g., temperature, pressure, fluid flow, fracturing, reservoir compaction, emissions etc.).

As another example of a numerical technique, consider the finite element method where space may be represented by one dimensional or multi-dimensional “elements”. For one spatial dimension, an element may be represented by two nodes positioned along a spatial coordinate. For multiple spatial dimensions, an element may include any number of nodes. Further, some equations may be represented by the total number nodes while others are represented by fewer than the total number of nodes (e.g., consider an example for the Navier-Stokes equations where fewer than the total number of nodes represent pressure). The finite element method may include providing nodes that can define triangular elements (e.g., tetrahedra in 3D, higher order simplexes in multidimensional spaces, etc.) or quadrilateral elements (e.g., hexahedra or pyramids in 3D, etc.), or polygonal elements (e.g., prisms in 3D, etc.). Such elements, as defined by corresponding nodes of a grid, may be referred to as grid cells.

Yet another example of a numerical technique is the finite volume method. For the finite volume method, values for model equation variables may be calculated at discrete places on a grid, for example, a node of the grid that includes a “finite volume” surrounding it. The finite volume method may apply the divergence theorem for evaluation of fluxes at surfaces of each finite volume such that flux entering a given finite volume equals that leaving to one or more adjacent finite volumes (e.g., to adhere to conservation laws). For the finite volume method, nodes of a grid may define grid cells.

Where a sedimentary basin (e.g., subsurface region) includes various types of features (e.g., stratigraphic layers, fractures, faults, etc.), nodes, cells, etc., may represent, or be assigned to, such features. In turn, discretized equations may better represent the sedimentary basin and its features. As an example, a structured grid that can represent a sedimentary basin and its features, when compared to an unstructured grid, may allow for more simulations runs, more model complexity, less computational resource demands, less computation time, etc. In various examples, a structured approach and/or an unstructured approach may be utilized.

While various types of modelling can model subsurface regions and/or surface equipment (e.g., pipelines, pumps, separators, etc.), modelling can include energy and/or emissions modeling. For example, consider modelling of energy and emissions of a gas turbine electrical power generator that may provide electrical power to one or more electric submersible pumps (ESPs), which can be utilized as artificial lift equipment for production and/or as injection equipment to inject fluid, chemicals, etc. In such an example, a workflow may include coupling of multiple types of physical phenomena, which may be assessed with respect to one or more goals for a field that can include emissions goals. In the foregoing example, a gas turbine electrical power generator is mentioned, which, in various examples, may be one option that may be powered by hydrocarbon gas produced from a field. In various instances, one or more other options may be available such as, for example, grid power, wind power, solar power, wave power, diesel power, etc. As an example, a framework can include modelling capabilities for planning, assessing, controlling, etc., one or more field operations in an effort to meet one or more goals, which can include, for example, emissions goals. As an example, a framework may include one or more energy and/or emissions models. For example, consider one or more models that can relate energy required to break rock with a drill bit of a drillstring and emissions from one or more sources of power to drive the drill bit, pump drilling fluid (e.g., mud), etc.

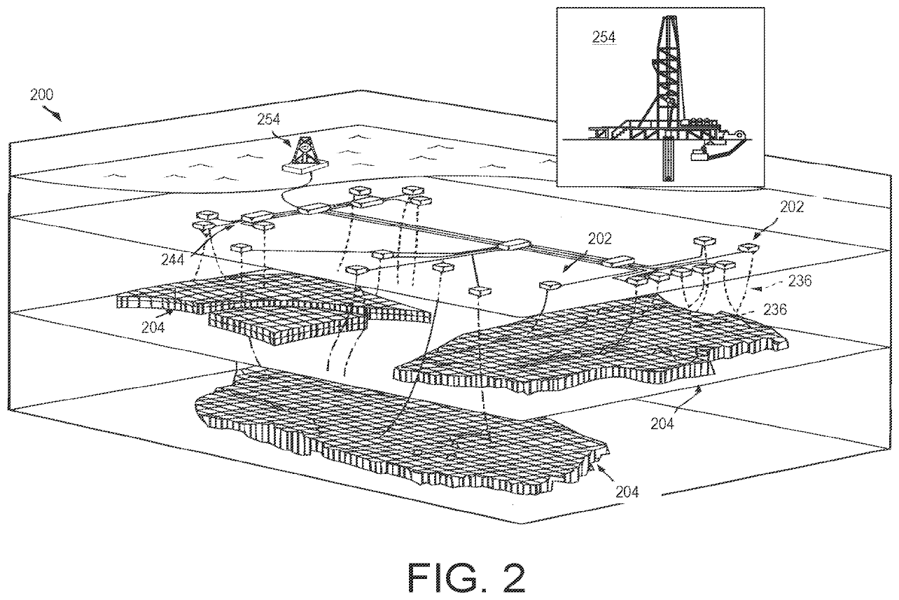

FIG. 2 shows an example of a geologic environment 200 as including various types of equipment and features. As shown, the geologic environment 200 includes a plurality of wellsites 202, which may be operatively connected to a processing facility. In the example of FIG. 2, individual wellsites 202 can include equipment that can form individual wellbores 236. Such wellbores can extend through subterranean formations including one or more reservoirs 204. Such reservoirs 204 can include fluids, such as hydrocarbons (e.g., gas and/or liquid). As an example, wellsites can provide for flow of fluid from one or more reservoirs and pass them to one or more processing facilities via one or more surface networks 244. As an example, a surface network can include tubing and control mechanisms for controlling flow of fluids from one or more wellsites to a processing facility. In the example of FIG. 2, a rig 254 is shown, which may be an offshore rig or an onshore rig. As an example, a rig can be utilized to drill a borehole that can be completed to be a wellbore where the wellbore can be in fluid communication with a reservoir such that fluid may be produced from the reservoir (e.g., or where fluid may be injected into the reservoir).

As mentioned, the geologic environment 200 can include various types of equipment and features. As an example, consider one or more sensors that can be located within the geologic environment 200 for purposes of sensing physical phenomena (e.g., pressure, temperature, flow rates, composition, density, viscosity, solids, flare character, compaction, etc.). As an example, equipment may include production equipment such as a choke valve where individual wells may each include a choke valve that can regulate flow of fluid from a well. As an example, equipment may include artificial lift equipment that can facilitate production of fluid from a reservoir. Artificial lift can be implemented as part of a production strategy whereby energy can be added to fluid to help initiate and/or improve production. Artificial lift equipment may utilize one or more of various operating principles, which can include, for example, rod pumping, gas lift, ESPs, etc. Referring again to FIG. 2, the operational decision block 260 may include planning for artificial lift, call for artificial lift, controlling one or more artificial lift operations, etc.

As an example, enhanced oil recovery (EOR) may be employed in the geologic environment 200, which may be based on one or more outputs of a system such as the system 200, the system 100, etc. EOR can aim to alter fluid properties, particularly properties of hydrocarbons. As an example, EOR may aim to restore formation pressure and/or improve oil displacement or fluid flow in a reservoir. EOR may include chemical flooding (e.g., alkaline flooding or micellar-polymer flooding), miscible displacement (e.g., carbon dioxide injection or hydrocarbon injection), thermal recovery (e.g., steam flood or in-situ combustion), etc. EOR may depend on factors such as reservoir temperature, pressure, depth, net pay, permeability, residual oil and water saturations, porosity and fluid properties such as oil API gravity and viscosity. EOR may be referred to at times as improved oil recovery or tertiary recovery.

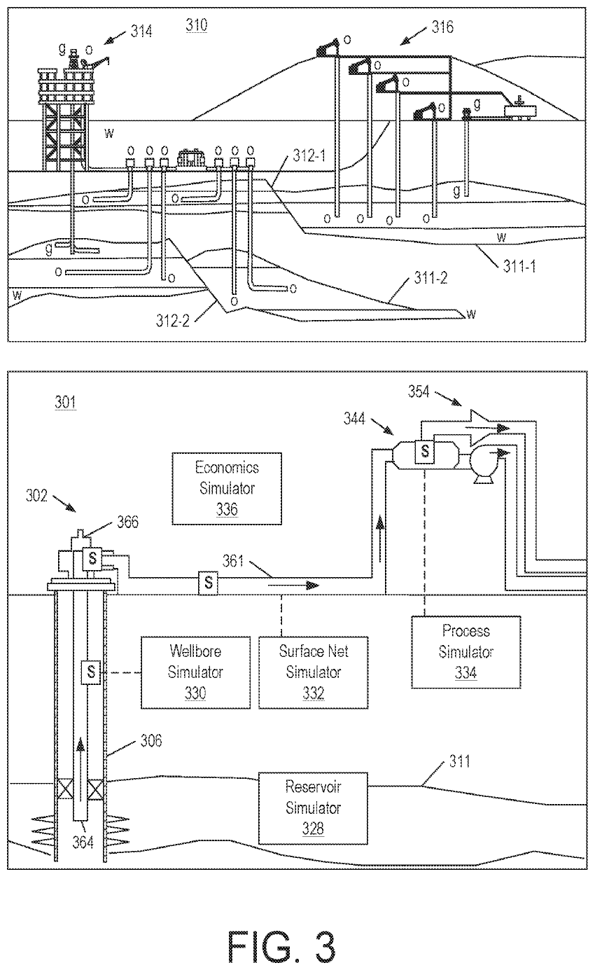

FIG. 3 shows an example of portion of a geologic environment 301 and an example of a larger portion of a geologic environment 310. As shown, a geologic environment can include one or more reservoirs 311-1 and 311-2, which may be faulted by faults 312-1 and 312-2 and which may include oil (o), gas (g) and/or water (w). FIG. 3 also shows some examples of offshore equipment 314 for oil and gas operations related to the reservoirs 311-1 and 311-2 and onshore equipment 316 for oil and gas operations related to the reservoir 311-1. As an example, a system may be implemented for operations associated with one or more of such reservoirs.

As to the geologic environment 301, FIG. 3 shows a schematic view where the geologic environment 301 can include various types of equipment. As shown in FIG. 3, the environment 301 can includes a wellsite 302 and a fluid network 344. In the example of FIG. 3, the wellsite 302 includes a wellbore 306 extending into earth as completed and prepared for production of fluid from a reservoir 311 (e.g., one of the reservoirs 311-1 or 311-2).

In the example of FIG. 3, wellbore production equipment 364 extends from a wellhead 366 of the wellsite 302 and to the reservoir 311 to draw fluid to the surface. As shown, the wellsite 302 is operatively connected to the fluid network 344 via a transport line 361. As indicated by various arrows, fluid can flow from the reservoir 311, through the wellbore 306 and onto the fluid network 344. Fluid can then flow from the fluid network 344, for example, to one or more fluid processing facilities.

In the example of FIG. 3, sensors(S) are located, for example, to monitor various parameters during operations. The sensors(S) may measure, for example, pressure, temperature, flowrate, composition, and other parameters of the reservoir, wellbore, gathering network, process facilities, and/or other portions of an operation. As an example, the sensors(S) may be operatively connected to a surface unit (e.g., to instruct the sensors to acquire data, to collect data from the sensors, etc.).

In the example of FIG. 3, a surface unit can include computer facilities, such as a memory device, a controller, one or more processors, and a display unit (e.g., for managing data, visualizing results of an analysis, etc.). As an example, data may be collected in the memory device and processed by the processor(s) (e.g., for analysis, etc.). As an example, data may be collected from the sensors(S) and/or by one or more other sources. For example, data may be supplemented by historical data collected from other operations, user inputs, etc. As an example, analyzed data may be used to in a decision making process.

As an example, a transceiver may be provided to allow communications between a surface unit and one or more pieces of equipment in the environment 301. For example, a controller may be used to actuate mechanisms in the environment 301 via the transceiver, optionally based on one or more decisions of a decision making process. In such a manner, equipment in the environment 301 may be selectively adjusted based at least in part on collected data. Such adjustments may be made, for example, automatically based on computer protocol, manually by an operator or both. In various instances, automation may be available at one or more levels of automation (e.g., very low, medium, high, very high). For example, if a system can be controlled at a high level of automation without experiencing issues, then that high level may be appropriate; whereas, if one or more issues occur at the high level of automation, then a lower level of automation may be selected. Levels of automation can be defined and implemented as part of an operational strategy that may involve a human in the loop (HITL). As an example, consider a controller that aims to maintain emissions below a certain level where the controller may operate at one or more levels of automation that can depend on feedback from the system that the controller controls. In such an example, where actual emissions deviate from expected emissions, level of automation may be decreased, which can include introducing a HITL. An assessment may be performed to determine why the deviation occurred, which may aim to rectify an issue such that the controller can resume control at a higher level of automation (e.g., consider making an adjustment to one or more control algorithms, etc.). As an example, one or more well plans may be adjusted, for example, to select optimum operating conditions, to avoid problems, etc.

To facilitate data analyses, one or more simulators may be implemented (e.g., optionally via the surface unit or other unit, system, etc.). As an example, data fed into one or more simulators may be historical data, real time data or combinations thereof. As an example, simulation through one or more simulators may be repeated or adjusted based on the data received.

In the example of FIG. 3, simulators can include a reservoir simulator 328, a wellbore simulator 330, a surface network simulator 332, a process simulator 334 and an economics simulator 336; noting that an energy and/or emissions simulator may be included. As an example, the reservoir simulator 328 may be configured to solve for hydrocarbon flow rate through a reservoir and into one or more wellbores. As an example, the wellbore simulator 330 and surface network simulator 332 may be configured to solve for hydrocarbon flow rate through a wellbore and a surface gathering network of pipelines. As to the process simulator 334, it may be configured to model a processing plant where fluid containing hydrocarbons is separated into its constituent components (e.g., methane, ethane, propane, etc.), for example, and prepared for further distribution (e.g., transport via road, rail, pipe, etc.) and optionally sale. As an example, the economics simulator 336 may be configured to model costs associated with at least part of an operation. For example, consider MERAK framework (SLB, Houston, Texas), which may provide for economic analyses.

As an example, a system can include and/or be operatively coupled to one or more of the simulators 328, 330, 332, 334, and 336 of FIG. 3. As an example, such simulators may be associated with frameworks and/or may be considered tools (see, e.g., the system 100 of FIG. 1, etc.). Various pieces of equipment in the example geologic environments 301 and 310 of FIG. 3 may be operatively coupled to one or more systems, one or more frameworks, etc. As an example, one or more of the sensors(S) may be operatively coupled to one or more networks (e.g., wired and/or wireless) for transmission of data, which, as explained, may include data indicative of production. As shown, a sensor(S) may be utilized for acquisition of downhole data and/or surface data, which can include data relevant to production (e.g., flow rate, temperature, pressure, composition, etc.). Such data may be utilized in a system such as, for example, the system 100 of FIG. 1 for operational decision making, etc.

While various examples of field equipment are illustrated for hydrocarbon related production operations, as explained, field equipment may be for one or more other types of operations where such field equipment can acquire data (e.g., field equipment data) that can be utilized for operation decision making and/or one or more other purposes. As to wind energy production equipment, data can include meteorological data associated with a site or sites, turbine blade data, turbine performance data, orientation control data, energy conversion data, etc. As to solar energy production equipment, data can include meteorological data associated with a site or sites, solar cell data, solar panel performance data, orientation control data, energy conversion data, etc. As an example, various types of data may be germane to energy production and emissions. For example, wind data can be relevant to generation of wind energy and dispersal of emissions.

As explained, field equipment data may be suitable for use with one or more frameworks, one or more workflows, etc. Uses of field equipment data can involve transfers such as, for example, inter-framework transfers where one or more types of data related issues may arise due to formatting, unit conversions, coordinate reference system (CRS) conversions, etc. Use of field equipment data can be enhanced through automated or semi-automated processes that can perform tasks such as identifying data (e.g., data types, etc.) and/or assessing quality of data.

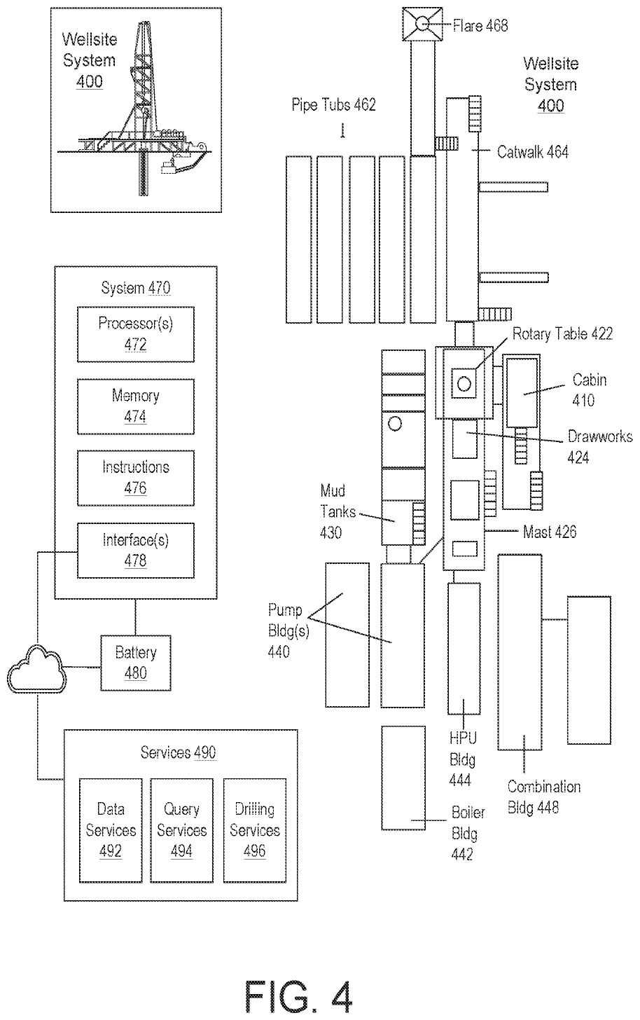

FIG. 4 shows an example of a wellsite system 400, specifically, FIG. 4 shows the wellsite system 400 in an approximate side view and an approximate plan view along with a block diagram of a system 470.

In the example of FIG. 4, the wellsite system 400 can include a cabin 410, a rotary table 422 (e.g., and/or top drive), drawworks 424, a mast 426 (e.g., optionally carrying a top drive, etc.), mud tanks 430 (e.g., with one or more pumps, one or more shakers, etc.), one or more pump buildings 440, a boiler building 442, an HPU building 444 (e.g., with a rig fuel tank, etc.), a combination building 448 (e.g., with one or more generators, etc.), pipe tubs 462, a catwalk 464, a flare 468, etc. Such equipment can include one or more associated functions and/or one or more associated operational risks, which may be risks as to time, resources, and/or humans.

As shown in the example of FIG. 4, the wellsite system 400 can include a system 470 that includes one or more processors 472, a memory 474 operatively coupled to at least one of the one or more processors 472, instructions 476 that can be, for example, stored in the memory 474, and one or more interfaces 478. As an example, the system 470 can include one or more processor-readable media that include processor-executable instructions executable by at least one of the one or more processors 472 to cause the system 470 to control one or more aspects of the wellsite system 400. In such an example, the memory 474 can be or include the one or more processor-readable media where the processor-executable media can be or include instructions. As an example, a processor-readable medium can be a computer-readable storage medium that is not a signal and that is not a carrier wave.

FIG. 4 also shows a battery 480 that may be operatively coupled to the system 470, for example, to power the system 470. As an example, the battery 480 may be a back-up battery that operates when another power supply is unavailable for powering the system 470. As an example, the battery 480 may be operatively coupled to a network, which may be a cloud network. As an example, the battery 480 can include smart battery circuitry and may be operatively coupled to one or more pieces of equipment via a SMBus or other type of bus.

In the example of FIG. 4, services 490 are shown as being available, for example, via a cloud platform. Such services can include data services 492, query services 494, and drilling services 496. As an example, the services 490 may be part of a system such as the system 100 of FIG. 1, the system 200 of FIG. 2, the system 300 of FIG. 3, etc.

As an example, the system 470 may be utilized to generate one or more rate of penetration (ROP) drilling parameter values, which may, for example, be utilized to control one or more drilling operations.

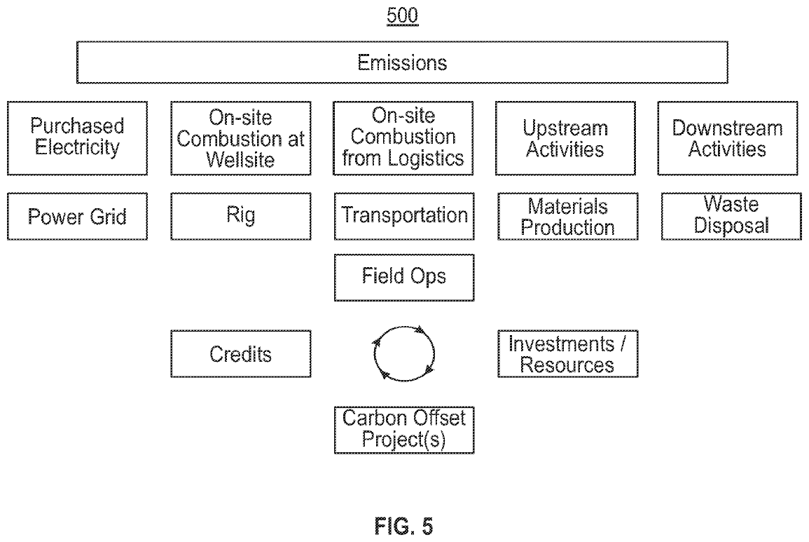

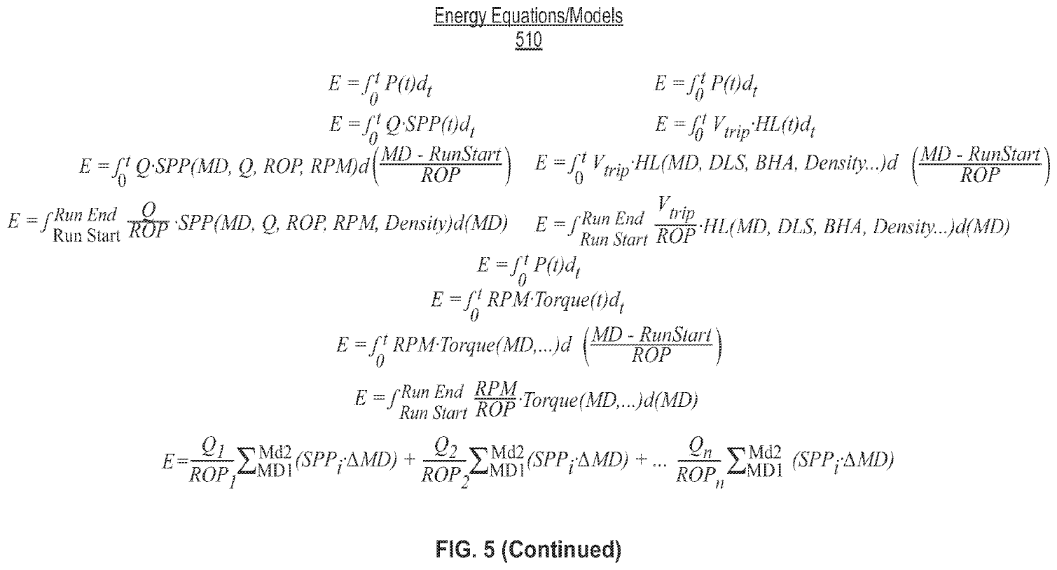

FIG. 5 shows an example of an emissions framework 500. As shown, emissions can include considerations as to electricity from a grid (e.g., solar, wind, hydroelectric, biomass, sea motion, power plant, etc.), on site combustion, off site combustion (e.g., logistics, etc.), upstream activities (e.g., production of materials, etc.), downstream activities (e.g., waste disposal, reprocessing, remediation, etc.), etc. FIG. 5 also shows a cycle involving field operations, investments/resources, carbon offset project(s) and credits.

FIG. 5 also shows some examples of equations 510 that may be utilized. As shown, energy (E) for drill to depth may be determined using various parameters (e.g., standpipe pressure (SPP) and flow rate (Q)), where E can depend on measured depth (MD), Q, rate of penetration (ROP), RPM, density, etc. As shown, integration of power (P(t)) may be performed with respect to time (dₜ), for example, from a time of 0 to a time t, where MD increases by some distance, which may be represented by a RunStart MD at time 0 and a RunEnd MD at time t. As shown in FIG. 5, the product of Q and SPP can be integrated, where SPP can depend on MD, Q, ROP, RPM, and density. In FIG. 5, various integrations with respect to time can be transformed into integrations with respect to MD. For example, consider representing dₜ as ((MD-RunStart)/ROP) and then reformulating the integral for E.

As to trip out energy, consider velocity of a trip (Vₜᵣᵢₚ) and hook load (HL), where HL can depend on MD, dog leg severity (DLS), BHA, density, etc., where the product of Vₜᵣᵢₚ and HL may be integrated with respect to time (dₜ).

As to mechanical energy, consider utilization of RPM and torque as may be integrated with respect to time as MD is increased (e.g., during drilling, etc.). As shown, torque can depend on MD and optionally one or more other variables. As an example, a method may utilize a formulation of a series of sums of individual variable values, for example, to account for different values of Q, ROP, SPP, etc., during drilling from one MD to another MD. As an example, physics-based models, data-based models (e.g., machine learning models, etc.) and/or hybrid models may be utilized for determining energy, emissions, etc. As an example, a model may provide for classification and/or prediction.

In the field of emissions, a carbon offset is an investment in an activity that reduces carbon emissions where, for example, a reduction in carbon emissions can be represented by a carbon credit. In such an example, a credit, usually verified by a third party, signifies that greenhouse gas emissions are lower than they would have been had no one invested in the offset. In various instances, one credit equals one metric ton of carbon dioxide prevented from entering the atmosphere. According to various schemes, a credit purchaser can use the credit for carbon accounting.

As an example, for field operations in an area that may have little to no available renewable power, the field operations may be performed in a manner to reduce electricity usage through energy efficiency improvements, which can include optimization of field operations. In such a scenario, a power provider and/or a power consumer may explore providing and/or consuming more “green” power. Where such options may not be readily attainable (e.g., additional green energy sources close to field operations, no plans to build more in the near future, etc.), it may be possible to use offsets to fund projects that reduce greenhouse gas emissions, indirectly reducing a total carbon footprint. For example, if a large farm produces animal waste near a field operation, such as livestock waste for production of methane (a particularly potent greenhouse gas that can be more than 20 times contributing as carbon dioxide), a project that allows the farm to collect waste and produce methane, as a financial sponsor, the field operations entity may receive credit (e.g., for acting in a manner reducing global greenhouse gas emissions. As an example, a credit may be applied to a carbon “footprint” that can offset emissions, for example, from using non-renewable energy.

As an example, a framework can provide for intelligent green asset management, planning and/or control, which may provide for realizing production and emissions targets with reduced utilization of resources (e.g., humans, machines, particular types of energy, etc.).

When looking at the current distribution of CO2 emissions by energy source, natural gas is a known contributor. In some nations, natural gas is utilized as a main source of energy to generate electricity, whilst the use of renewable energy in such nations may be at a relatively low level. In a systems approach to energy generation, energy utilization and generation of emissions, various sub-systems may be taken into account where relationships between those sub-systems can be characterized, which may be by direct and/or indirect characterization. As an example, one or more machine learning (ML) approaches may be implemented to characterize and/or uncover relationships. As an example, one or more models can be provided and/or built to help understand the origin of emissions and strategies by which they might be decreased where operational tasks are to be performed such as, for example, operational tasks involved in the production of hydrocarbons (e.g., oil and/or gas).

As a field is developed for production of hydrocarbons, various operational tasks will be linked to emissions in some way. To effectively manage emissions, potential alternative energy sources, and/or energy efficiency may be considered. Such management may help to contribute substantially to reductions in emissions in an effort to meet one or more goals. Various technologies such as, for example, CO2 capture, which may be via sequestration, may be taken into account. As an example, a framework can provide for assessing CO2 capture, hydrogen production, and renewable energy in an effort to meet one or more emissions reduction targets in a manner that can interface with plan generation and/or plan execution, which may span various phases of field development and production.

As an example, a framework can provide features for solving localized problems and for integrated intelligent processes that aim to solve problems at scale such as, for example, an optimization problem for operations production performance while minimizing emissions from a number of hydrocarbon assets (e.g., hydrocarbon reservoirs). A framework can include features that can advance solutions to issues that tend to be massive in scope where, for example, an asset scale may be utilized such that each asset is treated as a unit.

As an example, a framework can promote intelligent green asset management. In such an example, for each asset, a set of targets can be established along with concepts and constraints together with types of data to be accessed and/or acquired. As an example, such a framework can generate an optimal pathway that includes a list of actions to optimize hydrocarbon production while minimizing resource utilization and emissions.

As an example, a framework can operate to generate actions that can meet hydrocarbon production targets that have been set by following one or more strategies that can help to assure lowest possible costs and with fewest possible emissions. As mentioned, a framework can utilize data analytics and artificial intelligence (AI) technologies, such as, for example, machine learning (ML) techniques with various ML models. As an example, a framework can operate to generate a pathway of actions that can be implemented through minimizing additional expenses and carbon emissions. In such an example, the framework can be utilized in carrying out various actions of the pathway in efficient manners, which may account for one or more changes in conditions, equipment, operational tasks between generation of the pathway, and implementation of its actions.

As an example, a framework can provide for arranging activities, comprehending their interrelationships, and answering questions at desired points in time such as, for example, how can the cleanest operations be achieved for an asset and how can improved energy management, including, when possible, utilization of renewable energy be achieved. Such a framework may also provide answers as to how to manage effectively carbon abatement and/or utilization of carbon. Such a framework may include language components (e.g., one or more language models, natural language processing capabilities, etc.), data-driven models, physics-based models, etc. As an example, a framework may include generative pretrained transformer (GPT) capabilities, for example, trained in the realm of language associated with geology/geophysics, field operations, energy, and emissions. In such an example, outputs may be utilized in combinations with one or more other models, which may provide for pathway generation (e.g., data-driven models, physics-based models, etc.).

As an example, a framework may operate in a pillared manner where an asset is a unit that can be analyzed with respect to different pillars, which may be interrelated. As an example, pillars can range from planning to carbon abatement. A bias toward green with intelligence can be leveraged in a planning phase where a focus can be on recommending green field development plans (FDPs), which may include decision making and information as to why to drill one well rather than another well, which can include considering well construction CO2 footprint and/or CO2 emissions per distance unit drilling followed by prioritizing green drilling practices and working out options for greener production (e.g., one or more intelligent digital twin models such as for gas plant processing, etc.). As an example, a framework can include features for providing intelligent solutions for forecasting and optimizing the utilization of renewable energy. For example, consider weather forecasting that can indicate period of sun, amount of sun, periods of wind, amount of wind, direction of wind, etc. As mentioned, techniques can consider carbon storage and utilization as a means of combating an increase in emissions.

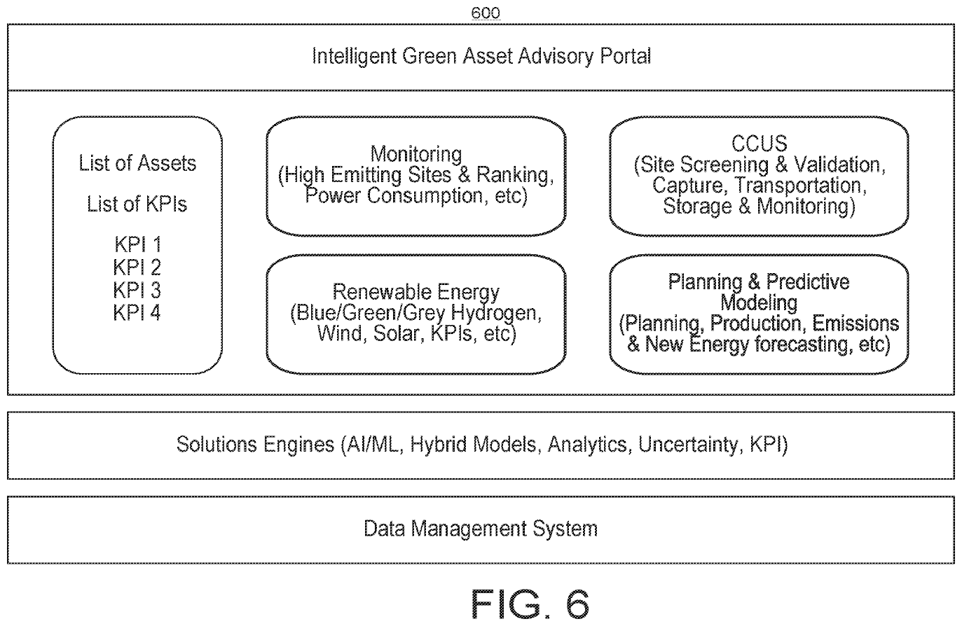

FIG. 6 shows an example of a graphical user interface (GUI) 600 that includes various graphical controls (GCs) that can be actuated to transition the GUI 600 to one or more other GUIs. As shown, a GC can provide for listing of assets and/or listing of performance indicators (PIs or “key” PIs (KPIs)); a GC can provide for monitoring such as, for example, identifying high emitting sites and ranking, power consumption, etc.; a GC can provide for carbon capture, utilization and storage (CCUS) information, which may provide for site screening and validation, capture, transportation, storage, and monitoring; a GC can provide for renewable energy information such as blue, green, and grey ratings as to hydrogen, wind, solar, etc., optionally along with performance indicators, etc.; and a GC can provide for planning and predictive modeling where planning, production, emissions and new energy forecasting tasks may be performed. As shown, the GUI 600 may provide for access to and use of one or more solution engines (e.g., AI/ML, hybrid models, analytics, uncertainty analysis, performance indicators, etc.) and may provide for access to and use of a data management system, which may be operatively coupled to one or more sources of data such as, for example, historical data, real-time data, etc. Various types of data can include field sensor data as may be present at a site associated with one or more assets and other types of data, which may pertain to weather, availability of energy, atmospheric conditions (e.g., levels of components in air, etc.), emissions (e.g., flaring, plumes, etc.), etc.

As an example, a framework can be at least in part cloud-based where cloud platform resources may be provisioned and scaled as appropriate to provide for solutions within a suitable timeframe. As an example, local equipment, which may include edge equipment, may be utilized. For example, consider a framework that can include components that are distributed such as local trained ML models that can operate using local computing devices that can transmit information to the cloud (e.g., via networks such as cellular, satellite, etc.) on an appropriate basis. In such an approach, local computing devices may have intelligent edge features that can trigger transmissions of information responsive to local processing of sensor data, which may help to reduce the amount of information and/or processing performed remote from a site or sites.

Where a field is considered that includes many assets such as many wells in fluid communication with one or more reservoirs, more data may be available for some wells in comparison to other wells. For example, a particular well or wells may be more heavily instrumented, more frequently surveyed, etc. As an example, a data-driven solution can utilize such data for building models that can operate on limited amounts and/or types of data where such models can predict data, behaviors, etc., for wells with lesser instrumentation, lesser survey frequency, etc. In such an approach, models can be improved over time as more data are acquired such that the number of surveys and/or survey frequency may be reduced at one or more wells, which can result in saving as to resources such as humans, transport of humans, transport of equipment, etc., to such a well or wells. Such an approach may help to reduce non-productive time (NPT) at one or more wells, one or more surface production networks, one or more processing facilities, etc. As to new wells, decisions may be made and set forth in a plan or plans as to instrumentation such that a well is not overly instrumented but rather instrumented to a level to meet compliance with regulations and to provide input to one or more trained models (e.g., trained ML models, etc.). Such an approach can conserve energy and help to reduce emissions, for example, by reducing transportation of equipment, reducing installation time for a human crew that may utilize power tools, reducing power demand, etc.

In the example of FIG. 6, the GUI 600 can be a comprehensive advisory portal via which data may be streamed from a variety of sources, to create analytics and intelligence, and determine timely actions to fulfill asset's PIs with access to various factors that influence production and emissions performance of one or more assets. As explained, a portal can provide access to a framework with monitoring capabilities to identify high emitting and power consuming sites and to prioritize a list of opportunities to leverage renewable energy at a competitive efficiency and cost. As an example, a system can include features to automatically plan for CCUS with complexity across a value chain from site screening, capturing, transportation, storage, and monitoring. A computational framework can include various predictive modeling capabilities to plan operations in a green manner while minimizing carbon footprint. A GUI can provide access to such capabilities for one or more purposes.

A portal can encompass field operations and other operations (e.g., business, etc.). As shown, PIs can be displayed to provide an overview of asset health status, where in each of different boxes, appropriate information in relation to emissions, renewable energy, CCUS current and planned activities, as well as planning and predictive modeling capabilities. As explained, a list of actions can be generated to be taken to improve performance of an asset. A framework can output a list of actions in a digital form that can be suitable for transmission, which can include transmission to one or more controllers, etc. As an example, a list of actions along with corresponding value production can be displayed.

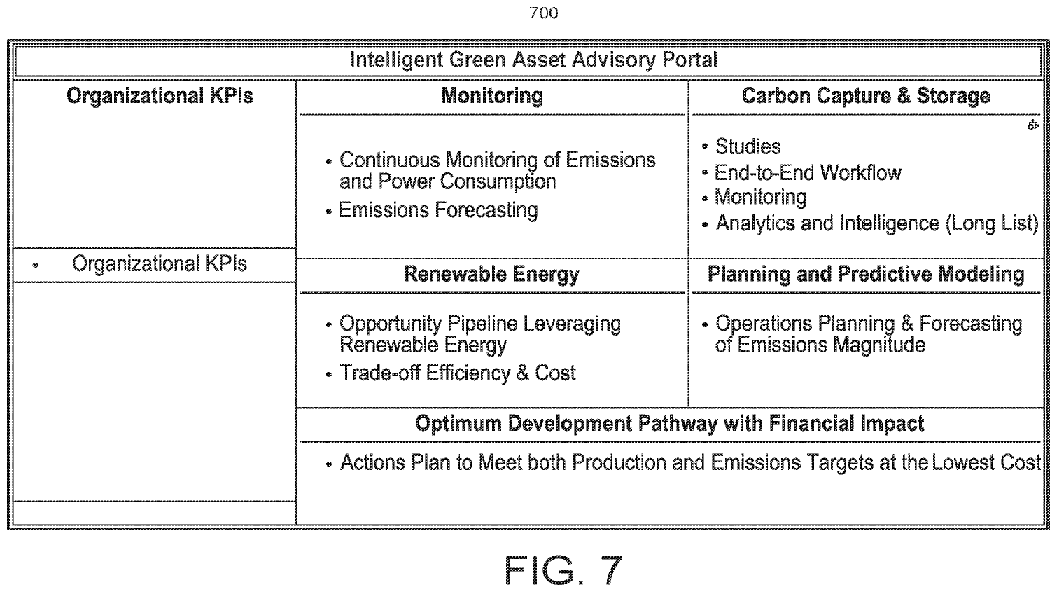

FIG. 7 shows an example of a GUI 700 that is in a schematic form with various features. Each of the features or sets of features can be provided using various components, which can include processor-executable instructions that may be used in a unified and/or a distributed manner. For example, sets of instructions can be utilized by provisioned cloud platform resources where instances of components can be generate in a dynamic manner responsive to demand, which can include user driven demand, data driven demand, etc.

As explained, a framework can provide tools to predict emissions and/or screen for renewable energy sources in combination with oil and gas assets' operations. Such a framework can supplement and in some instances replace instrument-based detection of emissions at one or more sites that can involve installation of hundreds of sensors such as optical gas imaging technology at different locations to cover all sites, which is costly, time-consuming, and impractical. As explained, a framework can include planning tools to estimate incremental emissions from different operations. For instance, consider components to estimate incremental emissions from increasing oil production, drilling infill wells, installing new valves and compressors etc. in one site. As explained, a framework can integrate various solutions from planning to operations to produce green asset model with optimized production strategies.

As an example, a workflow can include acquiring one-time methane emissions data from a number of different sites, which may be a number that is less than a total number of sites to be assessed. As an example, such data can be acquired by performing one-time extensive site visits by performing measurements such as downwind tracer flux methodology to quantify methane emissions and onsite observations with an infrared camera to identify emission sources. Such an approach may be referred to as a survey approach where a team of individuals are deployed with appropriate equipment to a site. A survey may be comprehensive and followed up by a less comprehensive survey if appropriate. For example, data can be utilized to train one or more ML models where testing can follow, which may include acquiring data to confirm predictions, classifications, etc., of one or more ML models. Once a ML model is validated, it may be suitably applied to a site and/or one or more other sites. As an example, a ML model can be configured to receive input, which may be a minimal amount of input such that a site does not demand a high level of instrumentation and/or human observation/interaction.

As an example, an advisory portal can display continuous monitoring of each asset's power consumption and emissions. This can be re-evaluated and predicted against planned activity in real time, highlighting high emitting sites, the source of emissions, and potentially a list of repair activities.

As an example, a framework can provides an intelligent appraisal of the value offered by renewable energy in terms of power generation capacity and cost reduction. Scheduled operations can be examined using predictive modeling approaches to ensure production targets are met while emissions projections are observed.

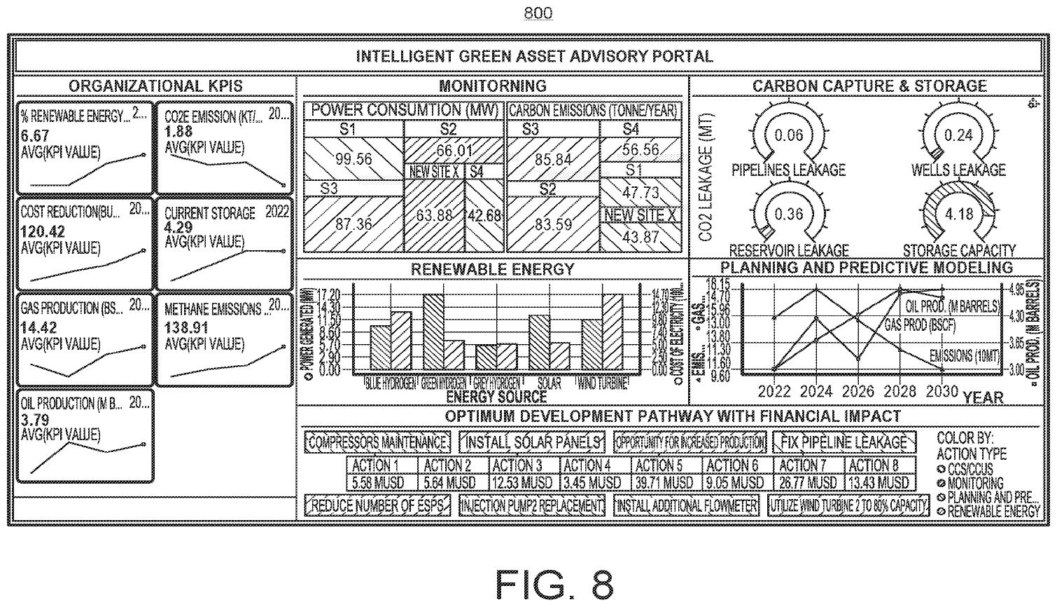

FIG. 8 shows an example of a GUI 800 that is populated with data and graphics, including output of a pathway with corresponding actions. The GUI 800 can be an intelligent green asset advisory portal for implementing analytics and intelligence with visualization. As shown, the GUI 800 includes graphics for a plurality of wells, including wells labeled S1, S2, S3, and S4.

A framework can provide for monitoring CCUS activities in terms of storage capacity, leaks, and prospective opportunities through intelligent site screening and validation. As shown, a GUI can summarize a list of actions derived from analytics and intelligence utilized to maximize production while addressing emissions. As explained, a result of a procedure can be a list of recommendations and activities to be evaluated for production of additional value. A GUI can be interactive such as by clicking on one or more graphics to render information as to impact on asset PIs, where an individual may continue to monitor the current health status of the asset in relation to the PIs.

A framework can be extensible to allow for the expansion of capabilities and the addition of new features, for example, consider features that contribute to computation of one or more PIs. A framework can progressively digitally alter an organization to meet increasing demands. As explained, a framework can include models that can learn as data are acquired and assessed, such a framework can gain in intelligence through operation of the framework.

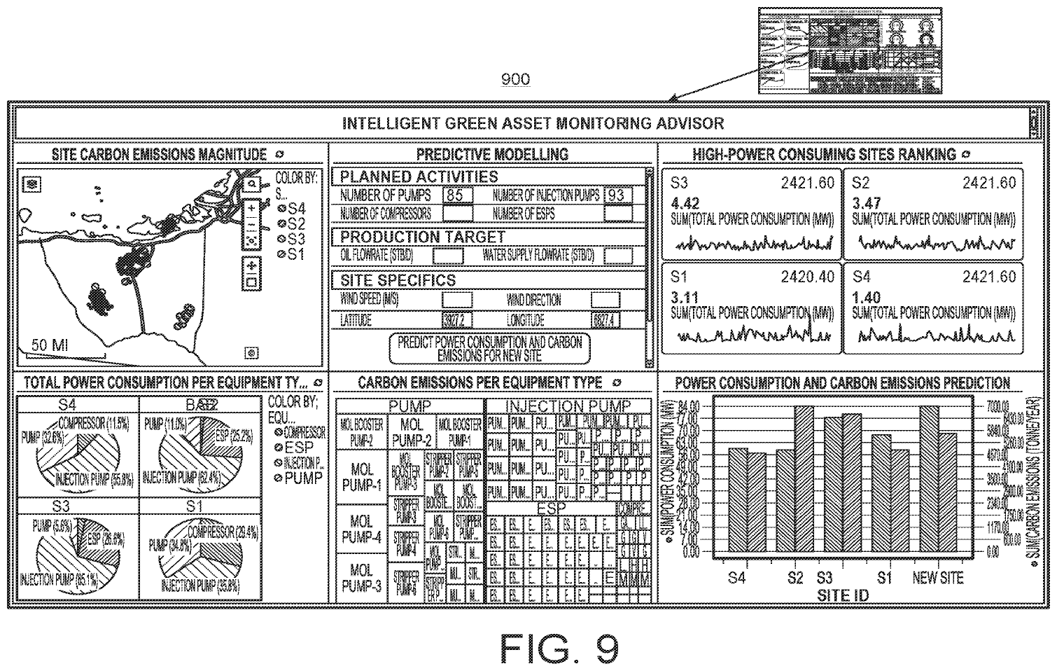

FIG. 9 shows an example of a GUI 900 that includes features for predictive modeling that can interact with various other panels of the GUI, for example, to facilitate input and/or visualization of output. One or more GUIs can be utilized to delve deeper into a certain area, for example, by clicking and switching to a different application to view analyses at a higher resolution. For instance, the GUI 900 may be rendered responsive to clicking on a monitoring panel of the GUI 800. In the GUI 900, an individual can monitor and forecast a site's energy use and its relationship to carbon emissions. In addition, the framework can facilitate forecasting of net power consumption and emissions for new locations based on projected activities and production goals. A framework can also consider equipment types, energy consumption, fuel gas consumption, oil output, gas price, and electricity price in order to optimize energy consumption and reduce net emissions. A framework can provide for prognostic health management as may be utilized to assess and estimate when emissions will reach a threshold in order to be proactive and take the proper action at the proper moment. While CO2 is mentioned in various examples, other forms of carbon can be considered such as methane and/or other hydrocarbons. A framework can provide an intelligent approach for both methane and carbon dioxide emissions, forecasting for more reliable renewable energy.

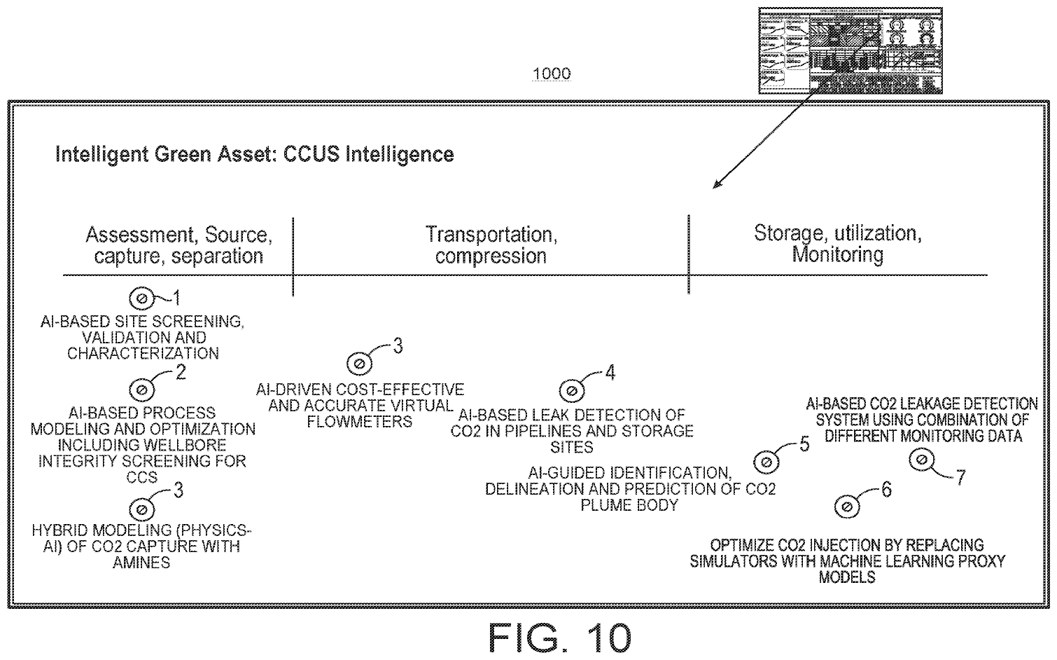

FIG. 10 shows an example of a GUI 1000 that can be accessed via the GUI 800 of FIG. 8. As shown, the GUI 1000 provides a portal for a CCUS advisor with a list of applications as there can be a variety of cost factors that may be handled using AI solutions. For example, consider AI-based site screening, validation, and characterization, the use of hybrid models for CO2 capture with amines, other CO2 sequestration techniques, gas processing plant optimization, screening plugged and abandoned wellbore integrity for CCS, leak detection, AI for CO2 plume tracking in the subsurface, and CO2 injection optimization.

As an example, a framework can generate output that drives assets toward green, in that emissions and/or energy utilization can be reduced while production and/or other targets are preserved or increased. A framework can support and guide strategic management decisions for introducing and implementing a new paradigm across different operator's assets, arriving at more green assets.

A framework can operate to reduce CO2 and/or methane emissions, for example, by identifying high emitter sites to prioritize maintenance but also to plan and produce the most optimal development scenarios that will result in the lowest emissions while achieving production growth ambitions. Again, the framework can generate pathways with actions to move assets toward a green asset goal.

A framework can include components that can be utilized to generate one or more applications for emissions monitoring, energy management, renewable energy resources identification, CCUS optimization and predictive modeling. As an example, a framework can be offered as standalone application, software as a service (SaaS), and/or as part of consultancy service.

As explained, existing methodologies that rely on installation of hundreds of sensors at different locations to cover the sites and stream data in real-time can be costly, time-consuming, and impractical. A framework can reduce such costs, for example, by acquiring one-time and/or relatively infrequent (e.g., annual, etc.) measurements to update a ML model or ML models that may be utilized for one or more purposes (e.g., classification, prediction, etc.). As an example, one or more digital twins may be built, which may represent an asset or a portion thereof. As explained, a framework can provide for predicting various types of emissions at different sites (e.g., methane emissions, CO2 emissions, etc.).

A framework can provide an integrated approach to emissions prediction with asset production optimization. Such a framework can approach an emissions reduction problem by producing an optimal green asset performance pathway for production growth strategy. A framework can enable operators to reduce time, resources and money spent on identifying high emitter sites for maintenance, leveraging renewable energy sources, and to produce optimal green assets. As explained, such tasks are relevant as oil and gas operators spend ever-increasing resources and money on activities related to installation and optimizing location of emission sensors and too little time on planning and producing the optimal asset production strategy, with little understanding of the value of these activities. An operator can use a framework for running day-to-day operations and improving decision-making processes.

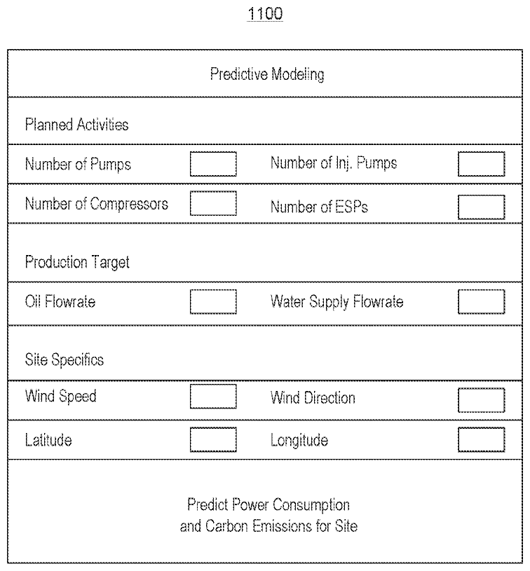

FIG. 11 shows an example of a GUI 1100 for predictive modeling, which can be driven by one or more trained ML models. As shown, planned activities, production targets and site specifics can be provided where a predictor can generate power consumption and/or carbon emissions predictions for a site. As explained with respect to FIG. 5, various modeling approaches can be utilized for purposes of prediction. While energy utilization equations or models are shown, emissions models may be included, which may be coupled to energy utilization equations, models, etc. As an example, where combustion occurs or is planned, equations for combustion may be utilized (e.g., flaring, gas turbine electricity generation, diesel engine operations, etc.). As an example, one or more simulators may be integrated into and/or operatively coupled to a framework (e.g., via application programming interfaces, etc.) for purposes of planning, prediction, action implementation, etc.

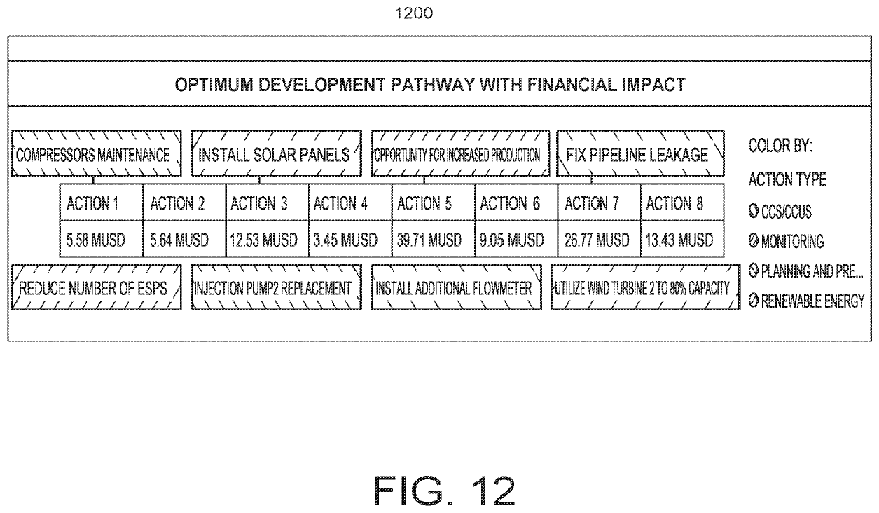

FIG. 12 shows an example of a GUI 1200 for output of a generated pathway with action items. As shown, the action items can be coded (e.g., color coded, numerically coded, etc.) to quickly understand how an action item related to a green asset strategy. As shown, the actions can be categorized and coded where one or more actions correspond to monitoring and can include compressor maintenance and injection pump replacement; one or more actions correspond to renewable energy and can include installation of solar panels and utilization of a wind turbine at a particular capacity; one or more actions correspond to CCUS and can include installation of an additional flowmeter and fixing pipeline leakage; and one or more actions correspond to planning and/or predicting such as reducing number of ESPs (see, e.g., the GUI 1100) and identifying an opportunity for increased production.

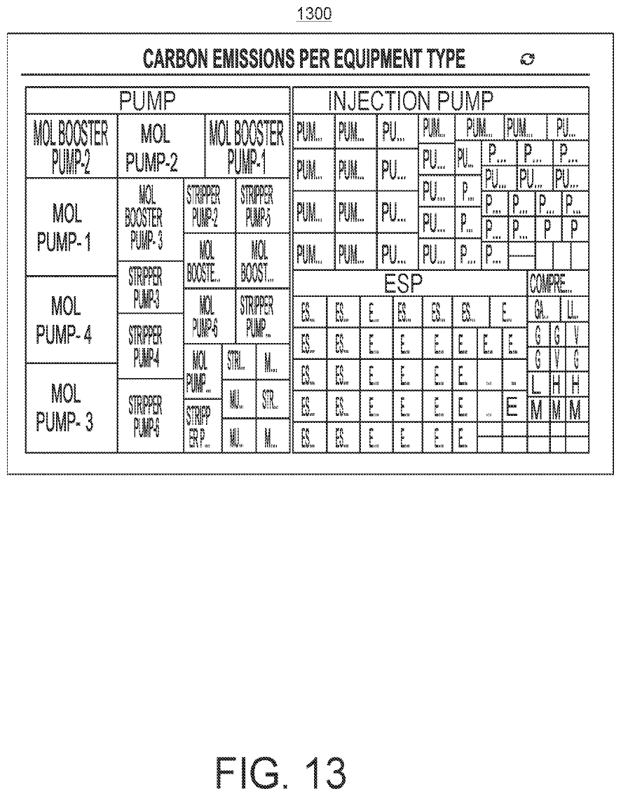

FIG. 13 shows an example of a GUI 1300 that includes information as to carbon emissions per equipment type, which includes pumps, injection pumps, ESP, etc. In such a GUI, an operator can readily identify how various equipment carbon emissions are occurring.

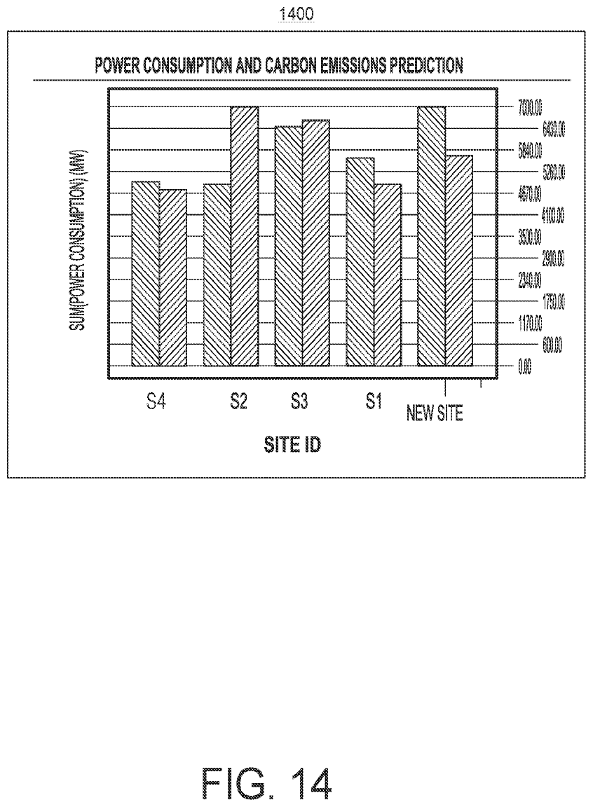

FIG. 14 shows an example of a GUI 1400 for power consumption and carbon emissions predictions, which can be an output of the GUI 1100. As shown, values can be presented for various sites. As an example, a method can include site ranking to explore why a site may be performing better than another site. Such an approach can be utilized in generation of a pathway of actions, for example, to improve one or more sites using information from a greener asset site.

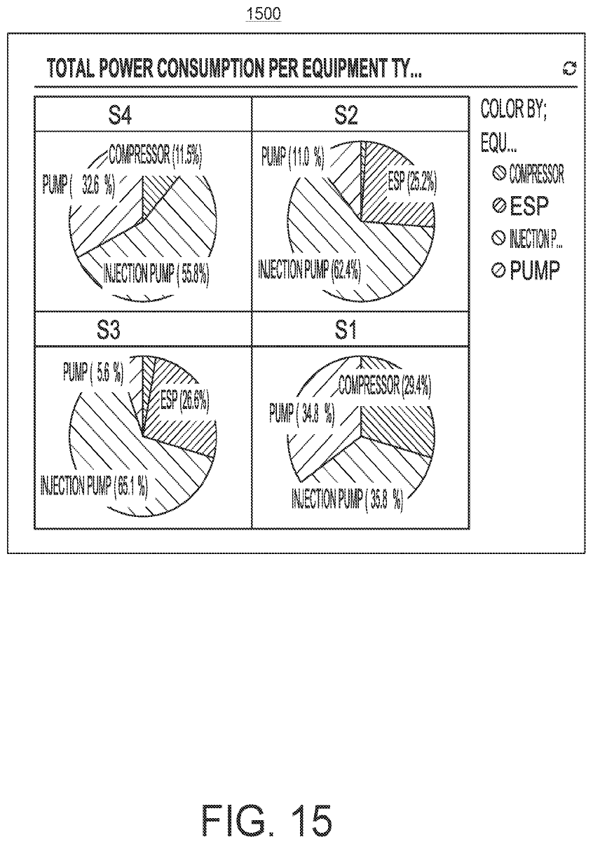

FIG. 15 shows an example of a GUI 1500 that includes pie charts for various sites that indicate total power consumption by equipment type, which can include, for example, equipment such as compressors, ESPs, injection pumps and other pumps. As shown, behavior can differ from site to site, though injection pumps may be the greatest contributor. In such an example, balances may be made between different technologies, which may provide for pathways of actions that can achieve more green assets.

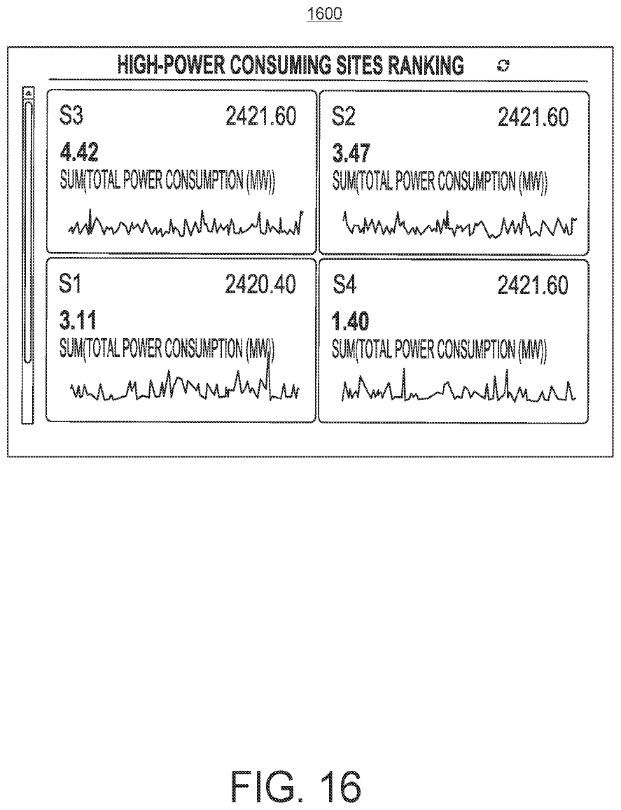

FIG. 16 shows an example of a GUI 1600 that includes power consuming sites rankings for various sites. Such information may be real-time and may include predictions based on real-time inputs. For example, one or more of the sites may be less instrumented than one or more other sites where one or more trained ML models can be utilized to fill-in results via predictions. A trained ML model may be operable in real-time or near real-time using real-time data to provide real-time or near real-time output such that various sites can be compared.

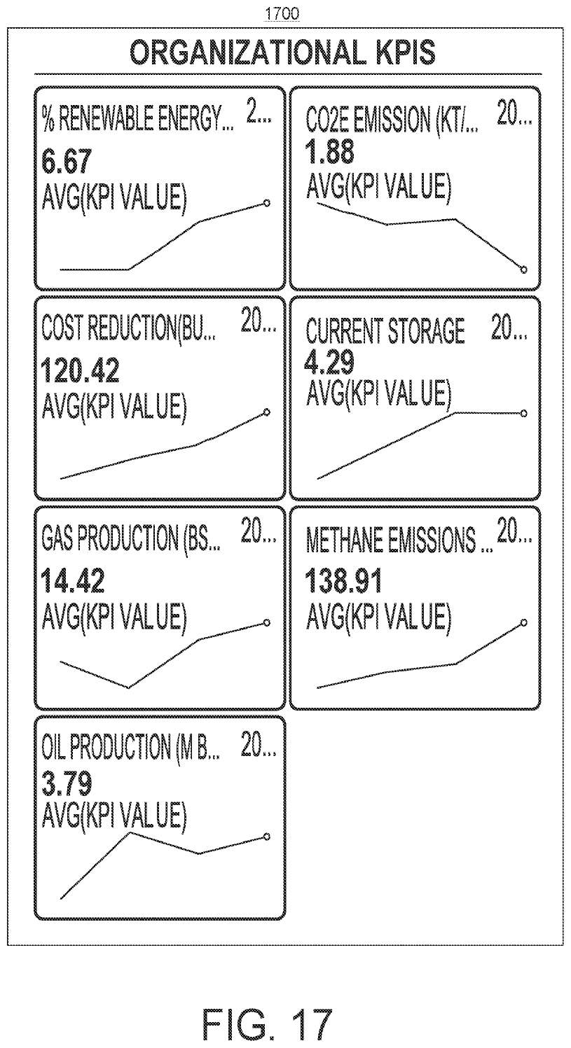

FIG. 17 shows an example of a GUI 1700 that includes performance indicators (e.g., PIs or KPIs), which may be on one or more scales. For example, consider the scale of an asset and the scale of a field of assets or fields of assets. In such an approach, an operator can assess progression as may be through implementation of generated pathways of actions (see, e.g., the GUI 1200). In the example of FIG. 17, the PIs include percent renewable energy, cost reduction, gas production, oil production, CO2 emissions, current storage, and methane emissions. Such a GUI may be tailored to include various selected PIs.

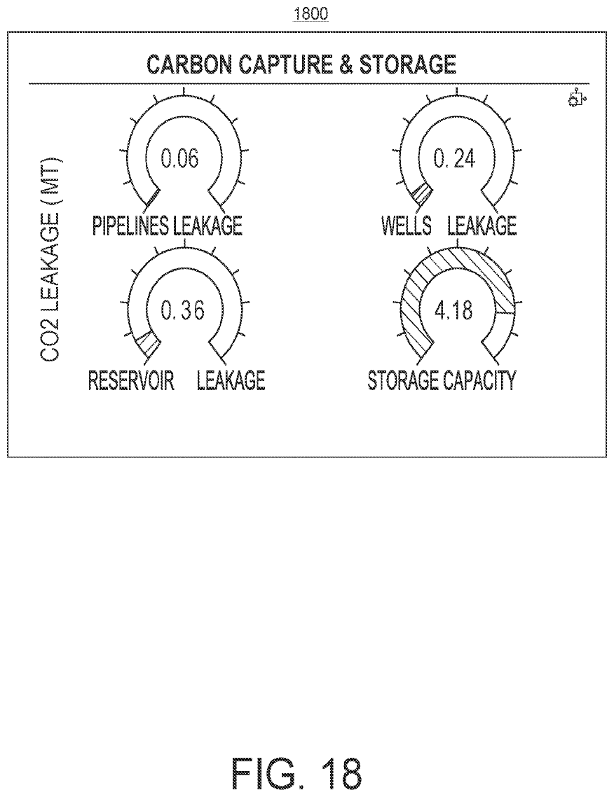

FIG. 18 shows an example of a GUI 1800 that includes information as to carbon capture and storage, which can include graphics for pipeline leakage, reservoir leakage, well leakage and storage capacity. As explained, a site may provide one or more mechanisms for storing carbon where capacity and/or utilization may be indicated. As explained, a pathway can include actions germane to CCUS, such as, for example, the example pathway of the GUI 1200.

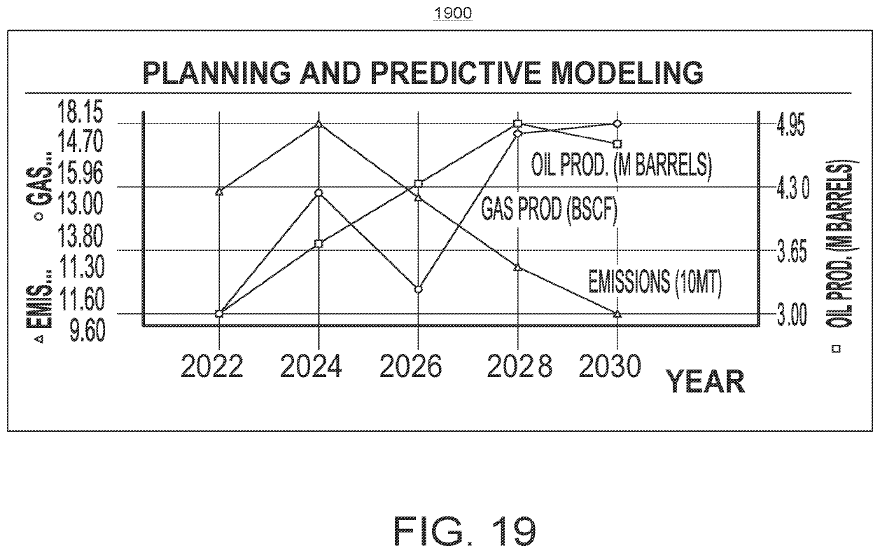

FIG. 19 shows an example of a GUI 1900 that includes information as to gas production, oil production and emissions. As shown, the information may be generated using predictive models such as one or more ML models. As explained, planning can generate actionable pathways where an operator can explore implementation of actions, as may be selected, on future production and/or emissions.

As an example, a framework can utilize simulation that implements one or more simulators, which may be physics-based, ML model based and/or hybrid. As an example, one or more proxy models may be utilized to represent a complex scenario as to one or more physical phenomena where a proxy model can run using fewer computational resources and/or in a real-time or near real-time manner. As explained, digital twins may be utilized to represent equipment and/or operations.

A framework can reduce demand for instrumentation and/or performance of site surveys. As explained, through modeling, virtualization can be achieved for at least some sites. For example, consider a field with 100 sites where 20 sites are surveyed to generate data where the data are sufficient for ML model training to model the other 80 sites (e.g., generation of suitable digital twins, etc.). In such an approach, data, which can be expensive to acquire, can be leveraged. A framework can reduce instrumentation and survey demands, while meeting or increasing production and reducing emissions.

As to the foregoing example with 100 sites, consider a clustering approach that can be applied to plans, equipment, operations, data, etc., from such sites to determine a reasonable number of groupings such as, for example, 20 groups that may be represented as 20 clusters. In such an example, a site that is near a centroid of a cluster may be taken as a representative site where additional data may be acquired for purposes of training a model that can be implemented to represent other sites in the cluster. As an example, available data from each site within a cluster may be utilized to generate a model for the cluster (e.g., group) where some sites may have more available data than other sites. As explained, one or more sites may be selected for performance of detailed surveys that acquired desired data that can help to increase accuracy of a model. A clustering approach can be utilized for one or more purposes, which can include decision making for instrumentation, surveys, etc. In various examples, if a site at or nearest to a centroid of a cluster is more remote and/or otherwise more difficult to access (e.g., by road, etc.), one or more accessibility factors can be taken into account, which, in turn, may provide for conservation of energy and reduced emissions with respect to site access. Hence, a framework can provide for intelligent site selection for purposes of modelling, which may also provide for energy conservation and/or emissions reduction.

As explained, a framework can include forecasting abilities such as sun, wind, weather forecasting to determine when renewable energy may be available. A pathway can include actions related to such determinations such as, for example, 6 months from now, utilize solar rather than a natural gas driven turbine generator for generation of a specified percentage of electricity at a site. Such an action can be implemented automatically, for example, via control signals issued by a framework to a site where the site includes one or more actuators that can be actuated for a balance of electricity generation techniques. As an example, a framework may provide for site selection as to the best site to implement one or more strategies. As explained, a clustering process may help to identify a site that is more representative of a group of sites than other sites in the group. In such an example, the identified site may be assessed to determine whether it is suitable for implementation of a particular strategy, which may result in further data acquisition and model building for a model that can be representative of the group of sites. Such an approach can expedite prediction of how other sites in the group of sites may perform with respect to production, energy utilization, and emissions. As explained, one or more digital twins may be generated, where, for example, each group of sites has at least one digital twin.

As an example, one or more data techniques may be utilized to augment data for purposes of machine learning. For example, consider a framework that includes a data adapter that can transform data from one site into suitable virtual data representative of another site where such data can be utilized in training and/or testing one or more ML models. In such an example, a clustering analysis may be utilized for purposes of data augmentation, where such clustering may be based on one or more factors relevant to field operations, energy utilization, emissions, modeling, etc.

As explained, satellite data may be utilized for one or more purposes (e.g., weather, transportation of people and/or equipment, emissions, etc.). As an example, a site may include local computational resources that can implement one or more types of virtual sensors. For example, consider a virtual flow meter that can be implemented using an edge device that can operate a lightweight version of a simulator such as, for example, the PIPESIM simulator. In such an example, the virtual flow meter may be calibrated periodically, for example, when a site test or survey is performed.

As explained, a pathway of actions can include a variety of actions that can pertain to different aspects of production, emissions, etc., where an overall goal is to move toward a more green asset. As explained, actions may include machine actions that can be transmitted digital, for example, as control signals to cause action to take place at a site, which may happen automatically, for example, responsive to review and approval of the action as in a pathway.

As an example, a machine learning framework can include one or more machine learning models. As an example, a multiple linear regression model (MLR model) can be a machine learning model (ML model). As an example, an artificial neural network (ANN) model can be a machine learning model (ML model). As an example, a trained ML model may be implemented for one or more purposes.

As an example, a ML model can be a non-physics-based ML model, a physics-based ML model and/or include one or more physics-based models. As an example, a ML model can be relatively light-weight, which may expedite learning and/or reduce computational resource demand to generate a trained ML model or ML models.

As to types of machine learning models, consider one or more examples such as a support vector machine (SVM) model, a k-nearest neighbors (KNN) model, an ensemble classifier model, a neural network (NN) model, etc. As an example, a machine learning model can be a deep learning model (e.g., deep Boltzmann machine, deep belief network, convolutional neural network (CNN), stacked auto-encoder, etc.), an ensemble model (e.g., random forest, gradient boosting machine, bootstrapped aggregation, AdaBoost, stacked generalization, gradient boosted regression tree, etc.), a neural network model (e.g., radial basis function network, perceptron, back-propagation, Hopfield network, etc.), a regularization model (e.g., ridge regression, least absolute shrinkage and selection operator, elastic net, least angle regression), a rule system model (e.g., cubist, one rule, zero rule, repeated incremental pruning to produce error reduction), a regression model (e.g., linear regression, ordinary least squares regression, stepwise regression, multivariate adaptive regression splines, locally estimated scatterplot smoothing, logistic regression, etc.), a Bayesian model (e.g., naïve Bayes, average on-dependence estimators, Bayesian belief network, Gaussian naïve Bayes, multinomial naïve Bayes, Bayesian network), a decision tree model (e.g., classification and regression tree, iterative dichotomiser 3, C4.5, C5.0, chi-squared automatic interaction detection, decision stump, conditional decision tree, M5), a dimensionality reduction model (e.g., principal component analysis, partial least squares regression, Sammon mapping, multidimensional scaling, projection pursuit, principal component regression, partial least squares discriminant analysis, mixture discriminant analysis, quadratic discriminant analysis, regularized discriminant analysis, flexible discriminant analysis, linear discriminant analysis, etc.), an instance model (e.g., k-nearest neighbor, learning vector quantization, self-organizing map, locally weighted learning, etc.), a clustering model (e.g., k-means, k-medians, expectation maximization, hierarchical clustering, etc.), etc.

As an example, a machine model, which may be a machine learning model, may be built using a computational framework with a library, a toolbox, etc., such as, for example, those of the MATLAB framework (MathWorks, Inc., Natick, Massachusetts). The MATLAB framework includes a toolbox that provides supervised and unsupervised machine learning algorithms, including support vector machines (SVMs), boosted and bagged decision trees, k-nearest neighbor (KNN), k-means, k-medoids, hierarchical clustering, Gaussian mixture models, and hidden Markov models. Another MATLAB framework toolbox is the Deep Learning Toolbox (DLT), which provides a framework for designing and implementing deep neural networks with algorithms, pretrained models, and apps. The DLT provides convolutional neural networks (ConvNets, CNNs) and long short-term memory (LSTM) networks to perform classification and regression on image, time-series, and text data. The DLT includes features to build network architectures such as generative adversarial networks (GANs) and Siamese networks using custom training loops, shared weights, and automatic differentiation. The DLT provides for model exchange various other frameworks.

As an example, the TENSORFLOW framework (Google LLC, Mountain View, CA) may be implemented, which is an open source software library for dataflow programming that includes a symbolic math library, which can be implemented for machine learning applications that can include neural networks. As an example, the CAFFE framework may be implemented, which is a DL framework developed by Berkeley AI Research (BAIR) (University of California, Berkeley, California). As another example, consider the SCIKIT platform (e.g., scikit-learn), which utilizes the PYTHON programming language. As an example, a framework such as the APOLLO AI framework may be utilized (APOLLO.AI GmbH, Germany). As an example, a framework such as the PYTORCH framework may be utilized (Facebook AI Research Lab (FAIR), Facebook, Inc., Menlo Park, California).

As an example, a training method can include various actions that can operate on a dataset to train a ML model. As an example, a dataset can be split into training data and test data where test data can provide for evaluation. A method can include cross-validation of parameters and best parameters, which can be provided for model training.

The TENSORFLOW framework can run on multiple CPUs and GPUs (with optional CUDA (NVIDIA Corp., Santa Clara, California) and SYCL (The Khronos Group Inc., Beaverton, Oregon) extensions for general-purpose computing on graphics processing units (GPUs)). TENSORFLOW is available on 64-bit LINUX, MACOS (Apple Inc., Cupertino, California), WINDOWS (Microsoft Corp., Redmond, Washington), and mobile computing platforms including ANDROID (Google LLC, Mountain View, California) and IOS (Apple Inc.) operating system based platforms.

TENSORFLOW computations can be expressed as stateful dataflow graphs; noting that the name TENSORFLOW derives from the operations that such neural networks perform on multidimensional data arrays. Such arrays can be referred to as “tensors”.

As an example, a device and/or distributed devices may utilize TENSORFLOW LITE (TFL) or another type of lightweight framework. For example, one or more pieces of equipment at a wellsite may include and/or utilize a lightweight framework suitable for execution of a machine learning model (e.g., a trained ML model, etc.). TFL is a set of tools that enables on-device machine learning where models may run on mobile, embedded, and IoT devices. TFL is optimized for on-device machine learning, by addressing latency (no round-trip to a server), privacy (no personal data leaves the device), connectivity (Internet connectivity is demanded), size (reduced model and binary size) and power consumption (e.g., efficient inference and a lack of network connections). TFL provides multiple platform support, covering ANDROID and iOS devices, embedded LINUX, and microcontrollers. TFL provides diverse language support, which includes JAVA, SWIFT, Objective-C, C++, and PYTHON. TFL provides high performance, with hardware acceleration and model optimization. Using TFL, machine learning tasks may include, for example, data processing, image classification, object detection, pose estimation, question answering, text classification, etc., on multiple platforms.

As an example, field equipment may include one or more processors, cores, memory, etc., which may be deployed as a “box” or integrally to be locally powered and that can communicate locally and/or remotely with other equipment via one or more interfaces. As an example, one or more pieces of equipment may include computational resources that can be akin to those of an AGORA gateway or more or less than those of an AGORA gateway. As an example, an AGORA gateway may be a network device. Such a device may be an edge device that can perform one or more local actions and may include features for virtualization such as, for example, implementation of a virtual sensor (e.g., a virtual flow meter, etc.). As explained, an edge device may implement a ML framework that is suitable for execution of one or more ML models locally at a site, which may generate data, processed data, triggers, control actions, etc.

As an example, one or more pieces of field equipment can include one or more features of an AGORA gateway (e.g., v.202, v.402, etc.). For example, consider an INTEL ATOM E3930 or E3950 Dual Core with DRAM and an eMMC and/or SSD. Such a gateway may include a trusted platform module (TPM), which can provide for secure and measured boot support (e.g., via hashes, etc.). A gateway may include one or more interfaces (e.g., Ethernet, RS485/422, RS232, etc.). As to power, a gateway may consume less than about 100 W (e.g., consider less than 10 W or less than 20 W). As an example, a gateway may include an operating system (e.g., consider LINUX DEBIAN LTS). As an example, a gateway may include a cellular interface (e.g., 4G LTE with Global Modem/GPS, etc.). As an example, a gateway may include a WIFI interface (e.g., 802.11 a/b/g/n). As an example, a gateway may be operable using AC 100-240 V, 50/60 Hz or 24 VDC. As to dimensions, consider a gateway that has a protective box with dimensions of approximately 10 in×8 in×4 in. As an example, such a computing device may include a framework, which may be a lightweight framework (e.g., TFL, etc.).

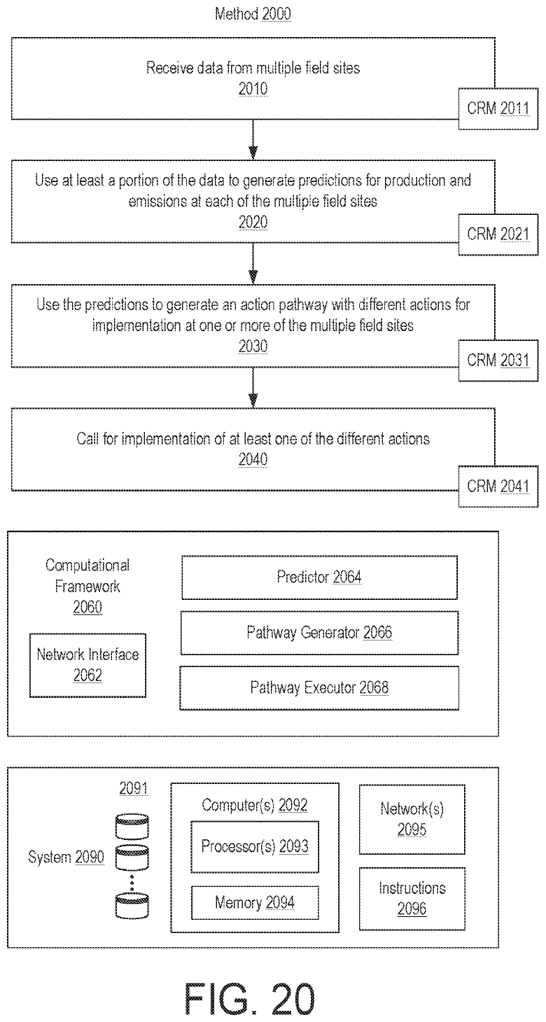

FIG. 20 shows an example of a method 2000, an example of a computational framework 2060, and an example of a system 2090. As shown, the method 2000 can include a reception block 2010 for receiving data from multiple field sites; a generation block 2020 for, using at least a portion of the data, generating predictions for production and emissions at each of the multiple field sites; and a generation block 2030 for, using the predictions, generating an action pathway with different actions for implementation at one or more of the multiple field sites. As shown, the method 2000 can include a call block 2040 for calling for implementation of at least one of the actions at one or more of the multiple field sites.

The method 2000 is shown along with various computer-readable media blocks 2011, 2021, 2031, and 2041 (e.g., CRM blocks). Such blocks may be utilized to perform one or more actions of the method 2000. For example, consider the system 2090 of FIG. 20 and instructions 2096, which may include instructions of one or more of the CRM blocks 2011, 2021, 2031, and 2041.

In the example of FIG. 20, the computational framework 2060 can include various components such as, for example, a network interface 2062, a predictor 2064, a pathway generator 2066, and a pathway executor 2068. In such an example, the components 2062, 2064, 2066, and 2068 can be utilized to perform various corresponding actions of the method 2000, for example, using instructions of the CRM blocks 2011, 2021, 2031, and 2041 (see, e.g., dashed lines). As an example, the computational framework 2060 can be part of the system 2090 or operatively coupled to the system 2090, for example, for execution of various instructions, etc.

As an example, the computational framework 2060 can include the network interface 2062 for receipt of data from multiple field sites; the processor-based predictor 2064 for utilization of at least a portion of the data to generate predictions for production and emissions at each of the multiple field sites; and the processor-based pathway generator 2066 for utilization of the predictions to generate an action pathway with different actions for implementation at one or more of the multiple field sites (e.g., via the pathway executor 2068). In such an example, the predictions for production and emissions can include predictions for hydrocarbon production and carbon emissions.

In the example of FIG. 20, a system 2090 includes one or more information storage devices 2091, one or more computers 2092, one or more networks 2095, and instructions 2096. As to the one or more computers 2092, each computer may include one or more processors (e.g., or processing cores) 2093 and a memory 2094 for storing the instructions 2096, for example, executable by at least one of the one or more processors. As an example, a computer may include one or more network interfaces (e.g., wired and/or wireless), one or more graphics cards, a display interface (e.g., wired or wireless), etc.

As an example, the system 2090 include or be operatively coupled to the computational framework 2060 where the computation framework 2060 can include the network interface 2062 that can receive data from multiple field sites; the processor-based predictor 2064 that utilizes at least one of the one or more processors 2096 and at least a portion of the data to generate predictions for production and emissions at each of the multiple field sites; and the processor-based pathway generator 2066 that utilizes at least one of the one or more processors 2096 and the predictions to generate an action pathway with different actions for implementation at one or more of the multiple field sites. As explained, a computational framework can include various instructions that can be executed for one or more purposes (see, e.g., the pathway executor 2068), which can include receiving data, generating predictions, generating action pathways, generating graphics, responding to interactions received from one or more GUIs, issuing one or more control commands for one or more actions (e.g., of an action pathway and/or another type of action), etc.

As an example, a computational framework can include a network interface that receives data from multiple field sites; a processor-based predictor that utilizes at least a portion of the data to generate predictions for production and emissions at each of the multiple field sites; and a processor-based pathway generator that utilizes the predictions to generate an action pathway with different actions for implementation at one or more of the multiple field sites. In such an example, the predictions for production and emissions can include predictions for hydrocarbon production and carbon emissions.

As an example, multiple field sites can correspond to assets and, where an action pathway is asset specific, the action pathway may be implemented to maintain or increase production and reduce emissions.

As an example, different actions of a pathway can include at least one field site monitoring action, at least one carbon emission related action, at least one renewable energy action and/or at least one planning action, which may be a prediction action. As an example, a carbon emission related action can be a carbon storage action. As an example, a renewable energy action can be a solar energy utilization action or a wind energy utilization action.

As an example, a computational framework can include a processor-based visualization generator that generates a hierarchy of graphical user interfaces operable to implement a predictor and a pathway generator. In such an example, the hierarchy of graphical user interfaces can include a pathway graphical user interface that renders different actions in association with one or more optimization metrics; a predictive modeling graphical user interface that renders fields for entry of a planned activity, a production target and site specifics; and/or a graphical user interface that renders real-time production and carbon emissions for the multiple field sites.

As an example, a predictor can include one or more trained machine learning models. As an example, multiple field sites can differ as to level of instrumentation. As an example, a predictor can include one or more trained machine learning models trained using field data from one or more of the multiple field sites that are at a higher level of instrumentation to generate predictions for one or more of the multiple field sites that are at a lower level of instrumentation.

As an example, a pathway generator can generate an optimal pathway for production and emissions goals for one or more field sites, which can correspond to one or more assets.

As an example, a method can include receiving data from multiple field sites; using at least a portion of the data, generating predictions for production and emissions at each of the multiple field sites; and using the predictions, generating an action pathway with different actions for implementation at one or more of the multiple field sites. In such an example, the method can include transmitting a control signal that corresponds to one of the different actions to one of the multiple field sites. As an example, a method can include transmitting instructions for rendering a graphical representation of the action pathway to a display, wherein the different actions form a sequence. As an example, generating predictions can include utilizing one or more machine learning models. In such an example, a machine learning model may be a trained machine learning model, for example, trained to make predictions based on field data. As explained, clustering may be utilized as part of a prediction process, which may, for example, provide for selecting one or more of various sites for purposes of modeling, data acquisition (e.g., surveys, instrumentation, etc.), etc. Clustering such as k-means clustering may be implemented where a variable “k” can be adjusted or optimized, for example, using an elbow technique. As explained, wells at various site may be grouped in an effort to reduce energy and/or emissions where one or more models can represent one or more groups (e.g., consider different digital twin models that can suitably model wellsite equipment and operations within different groups).

As an example, one or more non-transitory computer-readable storage media can include computer-executable instructions executable to instruct a computing system to: receive data from multiple field sites; using at least a portion of the data, generating predictions for production and emissions at each of the multiple field sites; and using the predictions, generating an action pathway with different actions for implementation at one or more of the multiple field sites.

As an example, a computer program product can include instructions to instruct a computing system to perform one or more methods as described herein.

As an example, a system may include instructions, which may be provided to analyze data, control a process, perform a task, perform a workstep, perform a workflow, etc.

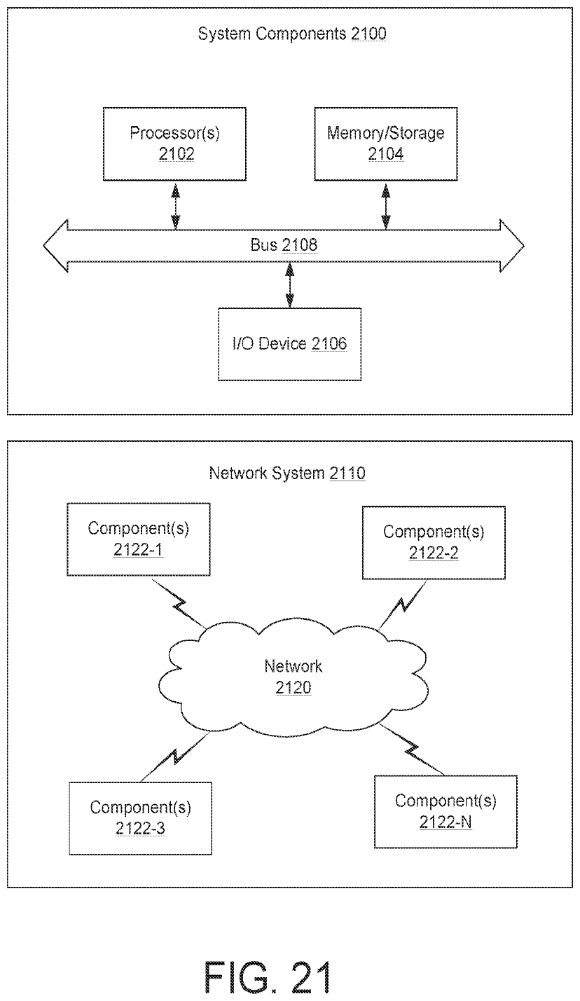

FIG. 21 shows components of an example of a computing system 2100 and an example of a networked system 2110 and a network 2120. The system 2100 includes one or more processors 2102, memory and/or storage components 2104, one or more input and/or output devices 2106 and a bus 2108. In an example embodiment, instructions may be stored in one or more computer-readable media (e.g., memory/storage components 2104). Such instructions may be read by one or more processors (e.g., the processor(s) 2102) via a communication bus (e.g., the bus 2108), which may be wired or wireless. The one or more processors may execute such instructions to implement (wholly or in part) one or more attributes (e.g., as part of a method). A user may view output from and interact with a process via an I/O device (e.g., the device 2106). In an example embodiment, a computer-readable medium may be a storage component such as a physical memory storage device, for example, a chip, a chip on a package, a memory card, etc. (e.g., a computer-readable storage medium).

In an example embodiment, components may be distributed, such as in the network system 2110, which includes the network 2120. The network system 2110 includes components 2122-1, 2122-2, 2122-3, . . . 2122-N. For example, the components 2122-1 may include the processor(s) 2102 while the component(s) 2122-3 may include memory accessible by the processor(s) 2102. Further, the component(s) 2122-2 may include an I/O device for display and optionally interaction with a method. The network may be or include the Internet, an intranet, a cellular network, a satellite network, etc.

As an example, a device may be a mobile device that includes one or more network interfaces for communication of information. For example, a mobile device may include a wireless network interface (e.g., operable via IEEE 802.11, ETSI GSM, BLUETOOTH, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A computational framework comprising:
a network interface that receives data from multiple field sites;
a processor-based predictor that utilizes at least a portion of the data to generate predictions for production and emissions at each of the multiple field sites; and
a processor-based pathway generator that utilizes the predictions to generate an action pathway with different actions for implementation at one or more of the multiple field sites.

2. The computational framework of claim 1, wherein the predictions for production and emissions comprise predictions for hydrocarbon production and carbon emissions.

3. The computational framework of claim 1, wherein the multiple field sites correspond to assets and wherein the action pathway is asset specific.

4. The computational framework of claim 1, wherein the different actions comprise at least one field site monitoring action, at least one carbon emission related action, and at least one renewable energy action.

5. The computational framework of claim 4, wherein the different actions comprise at least one planning action.

6. The computational framework of claim 4, wherein the at least one carbon emission related action comprises a carbon storage action.

7. The computational framework of claim 4, wherein the at least one renewable energy action comprises a solar energy utilization action or a wind energy utilization action.

8. The computational framework of claim 1, comprising a processor-based visualization generator that generates a hierarchy of graphical user interfaces operable to implement the predictor and the pathway generator.

9. The computational framework of claim 8, wherein the hierarchy of graphical user interfaces comprises a pathway graphical user interface that renders the different actions in association with one or more optimization metrics.

10. The computational framework of claim 8, wherein the hierarchy of graphical user interfaces comprises a predictive modeling graphical user interface that renders fields for entry of a planned activity, a production target and site specifics.

11. The computational framework of claim 8, wherein the hierarchy of graphical user interfaces comprises a graphical user interface that renders real-time production and carbon emissions for the multiple field sites.

12. The computational framework of claim 1, wherein the predictor comprises one or more trained machine learning models.

13. The computational framework of claim 1, wherein the multiple field sites differ as to level of instrumentation.

14. The computational framework of claim 13, wherein the predictor comprises one or more trained machine learning models trained using field data from one or more of the multiple field sites that are at a higher level of instrumentation to generate predictions for one or more of the multiple field sites that are at a lower level of instrumentation.

15. The computational framework of claim 1, wherein the pathway generator generates an optimal pathway for production and emissions goals.

16. A method comprising:
receiving data from multiple field sites;
using at least a portion of the data, generating predictions for production and emissions at each of the multiple field sites; and
using the predictions, generating an action pathway with different actions for implementation at one or more of the multiple field sites.

17. The method of claim 16, comprising transmitting a control signal that corresponds to one of the different actions to one of the multiple field sites.

18. The method of claim 16, comprising transmitting instructions for rendering a graphical representation of the action pathway to a display, wherein the different actions form a sequence.

19. The method of claim 16, wherein generating predictions comprises utilizing one or more machine learning models.

20. One or more non-transitory computer-readable storage media comprising computer-executable instructions executable to instruct a computing system to:
receive data from multiple field sites;
using at least a portion of the data, generating predictions for production and emissions at each of the multiple field sites; and
using the predictions, generating an action pathway with different actions for implementation at one or more of the multiple field sites.
